(19) United States
(12) Patent Application Publication
(10) Pub. No.: US 2005/0218137 A1
(43) Pub. Date: Oct. 6, 2005

(54) Portable hand holdable electric cigarette lighter

(76) Inventors: Tal Sela, Petach-Tikva (IL); Omer Bar, Petach Tikva (IL)

Correspondence Address: G.E. EHRLICH (1995) LTD.;c/o ANTHONY CASTORINA, SUITE 207, 2001 JEFFERSON DAVIS HIGHWAY, ARLINGTON, VA, 22202, US

(21) Appl. No.: 10/812,013

(22) Filed: Mar. 30, 2004

(51) Int. Cl. H01R 24/04; F23Q 7/00

(52) U.S. Cl. 219/262

(57) ABSTRACT

A portable hand holdable electric cigarette lighter conveniently locatable on top of furniture or a shelf, plugged into an electrical outlet, stored and/or moved, ready for immediate and routine use. The lighter includes an electrical resistance heating element contactable by a cigarette and connected to an electromechanical circuit supplied electrical power from an externally located alternating current, or from a built-in internally located direct current, power supply, and includes a portable hand holdable housing. The electromechanical circuit is connected to the heating element and connectable to ac power of 110 or 220 volts, and includes a step-down voltage transformer for providing voltage of 0.5-25 volts to the heating element, or, the electromechanical circuit is connected to the heating element and to dc power being batteries or an electromagnetic generator. Each electromechanical circuit includes one of two different types of a finger activatable/thermally responsive deactivatable actuating mechanism.

### FIELD AND BACKGROUND OF THE INVENTION

The present invention relates to electric cigarette lighters used for lighting cigarettes or cigars, and more particularly, to a portable hand holdable electric cigarette lighter which is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by an individual, ready for immediate and routine use for lighting a cigarette or cigar. The portable hand holdable electric cigarette lighter includes an electrical resistance heating element contactable by a cigarette, for lighting the cigarette, and operatively connected to an electromechanical circuit which is supplied electrical power either from an externally located alternating current (ac) power supply, or from a built-in internally located direct current (dc) power supply. The portable hand holdable electric cigarette lighter includes a portable hand holdable housing for housing the components therein, in a fully operable configuration.

The scope of the field and background of the present invention, and of the present invention itself, encompasses portable hand holdable electric lighting devices which are specifically designed, constructed, and used, for lighting cigarettes or cigars. Herein, for purposes of brevity and maintaining clarity of description, while not unnecessarily limiting generality of scope and applicability of the invention, the work pieces of the invention being cigarettes or cigars, are generally and equivalently referred to as cigarettes. Accordingly, it is to be understood, that the present invention, although ‘literally’ directed to and focused on a portable hand holdable electric ‘cigarette’ lighter, is clearly and fully applicable for functioning as a portable hand holdable electric ‘cigar’ lighter, and occasional reference is appropriately made to such applicability in the present disclosure.

Any of a wide variety of different types of disposable and reusable or refillable, portable hand holdable cigarette lighters which are well known, used, and taught about in the prior art, necessarily includes the following three main components, and associated functions thereof, in order to be considered self-contained and operable: (1) a manually operable cigarette or cigar lighting or flame generating mechanism connectable or connected to and fueled by (2) a fuel supply, typically being a quantity of pressurized (liquefied) propane or butane gas, stored in a built-in chamber having a fixed volume, and (3) a hand holdable housing or similar type of hand holdable means for holding and enabling operative connection of (1) and (2) in the form of an integral cigarette lighting device. Moreover, each of these three main components is ordinarily compactly sized and constructed for convenient operation by a user of the portable hand holdable cigarette lighter.

Among the most widely used types of disposable and reusable (refillable) portable hand holdable cigarette lighters, during typical use in moderate weather conditions, main components (1) and (3) ordinarily present no special limitations or shortcomings. However, during windy or drafty weather conditions, main component (1) is especially limited due to at least partial, and sometimes entire, blowing out of the generated flame. At the very least, a user needs to change to a position or move to a location having less wind or draft. Alternatively, a user needs to adjust the lighting or flame generating mechanism for receiving a larger than normal aliquot or feed of fuel from the fuel supply, followed by either re-adjusting the lighting or flame generating mechanism back to receiving the normal aliquot of fuel from the fuel supply, or leaving the lighting or flame generating mechanism in the adjusted configuration of receiving the larger than normal aliquot of fuel from the fuel supply during the next use of lighting the cigarette or cigar. The later action may be inconveniently unnecessary since either the windy or drafty condition may not be present during the next use, or the user may have changed to a position or moved to a location being free of the windy or drafty condition.

However, main component (2), that is, the fuel supply, presents two significant limitations, regardless of the portable hand holdable cigarette lighter being disposable or reusable (refillable). The first significant limitation is associated with usage of time and financial resources, whereby, when the fuel is depleted, in the case of a disposable portable hand holdable cigarette lighter, a user is required to take time and buy another portable hand holdable cigarette lighter, or, in the case of a reusable (refillable) portable hand holdable cigarette lighter, a user is required to take time and either refill or replace the fuel supply. As a matter of fact, for disposable portable hand holdable cigarette lighters, which are by far more widely used among the smoking population than reusable (refillable) portable hand holdable cigarette lighters, when the fuel is depleted, the cigarette lighting or flame generating mechanism is almost always still operable, but, nevertheless, the user discards the ‘entire’ disposable portable hand holdable cigarette lighter and buys another one. The second significant limitation is associated with safety considerations, and is applicable to either the case of a disposable or a reusable (refillable) portable hand holdable cigarette lighter. By this limitation, a user needs to avoid exposing or subjecting the cigarette lighter to conditions or potential conditions of excessive heat, flammability, and/or mechanical shock, since the cigarette lighter, as a consequence of including a fuel supply of pressurized (liquefied) propane or butane gas, is potentially hazardous (flammable and/or explosive).

The most widely known and used electric type of cigarette lighter is the electric cigarette lighter fully built into the dashboard, instrument or control panel, door arm rests, and/or back of a seat, of a vehicle, for example, an automobile or truck. A vehicular electric cigarette lighter necessarily includes the following three main components, and associated functions thereof, in order to be considered self-contained and operable as part of the vehicle: (1) a manually operable cigarette lighting or heat generating mechanism, typically including a removable appropriately housed electrical resistance heating element in the form of a metal coil, connectable or connected to and powered by (2) a direct current (dc) power supply, ordinarily being the vehicle battery as part of the vehicle electrical system, and (3) a housing unit built into the vehicle for holding and enabling operative connection of (1) and (2) in the form of an integral vehicular cigarette lighting device. Although very convenient to the smoking population during vehicular travel, a vehicular electric cigarette lighter is clearly not hand holdable or portable.

There is thus a need for, and it would be highly useful to have a portable hand holdable electric cigarette lighter which is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by an individual, ready for immediate and routine use for lighting a cigarette or cigar. Moreover, there is a need to have a portable hand holdable electric cigarette lighter which is absent of the above described limitations of prior art pressurized (liquefied) propane or butane gas fueled disposable and reusable (refillable) portable hand holdable cigarette lighters.

### SUMMARY OF THE INVENTION

The present invention relates to a portable hand holdable electric cigarette lighter which is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by an individual, ready for immediate and routine use for lighting a cigarette or cigar. The portable hand holdable electric cigarette lighter includes an electrical resistance heating element contactable by a cigarette, for lighting the cigarette, and operatively connected to an electromechanical circuit which is supplied electrical power either from an externally located alternating current (ac) power supply, or from a built-in internally located direct current (dc) power supply. The portable hand holdable electric cigarette lighter includes a portable hand holdable housing for housing the components therein, in a fully operable configuration.

The first preferred embodiment of the portable hand holdable electric cigarette lighter of the present invention, described hereinbelow and illustrated in FIGS. 1 and 2, features a specific physical and spatial layout or configuration, and geometrical dimensions, particularly ready for use when located on top of an article of furniture (for example, a desk or drawer unit) or a shelf, or directly plugged into a wall electrical outlet or other suitable electrical outlet. The second preferred embodiment of the portable hand holdable electric cigarette lighter of the present invention, described hereinbelow and illustrated in FIGS. 3 and 4, features a specific physical and spatial layout or configuration, and geometrical dimensions, particularly ready for use when being carried and moved around, for example, in a clothes pocket, purse, or small bag, but is also ready for use when located on top of an article of furniture or a shelf.

In the first preferred embodiment of the portable hand holdable electric cigarette lighter of the present invention, the electromechanical circuit is operatively connected to the electrical resistance heating element and connectable to an externally located alternating current power supply providing a primary voltage of about 110 volts or about 220 volts. The electromechanical circuit includes a step-down voltage transformer for transforming the primary voltage to a secondary voltage in a range of between about 0.5 volts and about 25 volts, such that the electromechanical circuit transmits electrical power having the secondary voltage to the heating element for lighting the cigarette or cigar. The first preferred embodiment of the portable hand holdable electric cigarette lighter also includes a portable hand holdable housing for housing the heating element and the electromechanical circuit in a fully operable configuration.

In the second preferred embodiment of the portable hand holdable electric cigarette lighter of the present invention, the electromechanical circuit is operatively connected to the electrical resistance heating element and to a built-in internally located direct current power supply, for example, one or more disposable or rechargeable batteries, or an electromagnetic direct current (dc) generator, for transmitting electrical power from the power supply to the heating element for lighting the cigarette or cigar. The second preferred embodiment of the portable hand holdable electric cigarette lighter also includes a portable hand holdable housing for housing the heating element, the power supply, and the electromechanical circuit in a fully operable configuration.

In each of the first and second preferred embodiments of the portable hand holdable electric cigarette lighter of the present invention, the electromechanical circuit includes an actuating mechanism which actuates heating of the heating element for lighting the cigarette or cigar.

In a first exemplary specific configuration, and alternative configurations thereof, of each of the first and second preferred embodiments of the portable hand holdable electric cigarette lighter of the present invention, the actuating mechanism is a finger activatable/thermally responsive finger deactivatable electromechanical mechanism, which is activated by the press or push of a finger and deactivated by release of the pressed or pushed finger in response to visual detection of an increase in temperature of the heating element to a desired cigarette or cigar lighting temperature, preferably, at least about 500° C. This type of electromechanical mechanism includes (1) a double-pole contactor switch assembly electromechanically connected to the conductive ends of the heating element and electromechanically connectable to part of the electromechanical circuit that transmits the necessary electrical power (ac or dc) from the power supply, and (2) a finger pressible/releaseable rod or bar assembly mechanically connected to the poles of the double-pole contactor switch assembly.

In a second exemplary specific configuration, and alternative configurations thereof, of each of the first and second preferred embodiments of the portable hand holdable electric cigarette lighter of the present invention, the actuating mechanism is a finger activatable/thermally responsive automatically deactivatable electromechanical mechanism, which is activated by the press or push of a finger and automatically deactivated in response to an increase in temperature of the heating element to a pre-determined threshold temperature, preferably, at least about 500° C., sufficient for lighting the cigarette or cigar. This type of electromechanical mechanism includes (1) a finger pressible removable contacting assembly contactable with (2) an automatic thermally expandable and releasable contacting assembly.

Thus, according to the present invention, there is provided a portable hand holdable electric cigarette lighter, comprising: (a) an electrical resistance heating element contactable by a cigarette, for lighting the cigarette; (b) an electromechanical circuit operatively connected to the heating element and connectable to an externally located alternating current power supply providing a primary voltage of about 110 volts or about 220 volts, the electromechanical circuit includes a step-down voltage transformer for transforming the primary voltage to a secondary voltage in a range of between about 0.5 volts and about 25 volts, such that the electromechanical circuit transmits electrical power having the secondary voltage to the heating element for the lighting; and (c) a portable hand holdable housing for housing the heating element and the electromechanical circuit.

According to further characteristics in preferred embodiments of the portable hand holdable electric cigarette lighter described below, the heating element is supported by non-conductive support elements which are part of or attached to the portable hand holdable housing.

According to further characteristics in preferred embodiments of the portable hand holdable electric cigarette lighter described below, the electromechanical circuit includes an actuating mechanism which actuates heating of the heating element.

According to further characteristics in preferred embodiments of the portable hand holdable electric cigarette lighter described below, the actuating mechanism is a finger activatable/thermally responsive finger deactivatable electromechanical mechanism, activated by press of a finger and deactivated by release of the pressed finger in response to visual detection of an increase in temperature of the heating element to a cigarette lighting temperature of at least about 500° C.

According to further characteristics in preferred embodiments of the portable hand holdable electric cigarette lighter described below, the actuating mechanism includes (1) a double-pole contactor switch assembly, and (2) a finger pressible/releasable rod or bar assembly.

According to further characteristics in preferred embodiments of the portable hand holdable electric cigarette lighter described below, the actuating mechanism is a finger activatable/thermally responsive automatically deactivatable electromechanical mechanism, activated by press of a finger and automatically deactivated in response to an increase in temperature of the heating element to a pre-determined threshold cigarette lighting temperature of at least about 500° C.

According to further characteristics in preferred embodiments of the portable hand holdable electric cigarette lighter described below, the actuating mechanism includes (1) a finger pressible and removable contacting assembly, contactable with (2) an automatic thermally expandable and releasable contacting assembly.

According to further characteristics in preferred embodiments of the portable hand holdable electric cigarette lighter described below, the finger pressible removable contacting assembly includes a longitudinally movable inner assembly having a first end portion positioned inside of a longitudinally movable outer assembly.

According to further characteristics in preferred embodiments of the portable hand holdable electric cigarette lighter described below, the wires lead from a pair of input conductive contact points of the step-down voltage transformer, pass through ports or openings of the portable hand holdable housing, and are operatively connectable to the externally located alternating current power supply.

According to further characteristics in preferred embodiments of the portable hand holdable electric cigarette lighter described below, the externally located alternating current power supply is a wall electrical outlet.

According to further characteristics in preferred embodiments of the portable hand holdable electric cigarette lighter described below, the wires passing through the ports or openings of the portable hand holdable housing, are plugged directly into a wall electrical outlet.

According to further characteristics in preferred embodiments of the portable hand holdable electric cigarette lighter described below, the ranges of values of geometrical dimensions of length, height, and width or depth, of the portable hand holdable housing are between about 5 cm and about 20 cm, between about 4 cm and about 15 cm, and between about 5 cm and about 15 cm, respectively.

According to further characteristics in preferred embodiments of the portable hand holdable electric cigarette lighter described below, the values of geometrical dimensions of length, height, and width or depth, of the portable hand holdable housing are about 14 cm, about 8 cm, and about 10 cm, respectively.

According to further characteristics in preferred embodiments of the portable hand holdable electric cigarette lighter described below, the heating element receives and handles a voltage of between about 0.5 volts and about 25 volts, and a current of up to about 10 amps.

According to further characteristics in preferred embodiments of the portable hand holdable electric cigarette lighter described below, the heating element is stable when heated to a temperature of at least about 500° C. within a time span of less than about one minute.

According to further characteristics in preferred embodiments of the portable hand holdable electric cigarette lighter described below, the heating element is made of a material selected from the group consisting of a pure metal, a metal alloy of at least two pure metals, an electrically conductive graphite material, an electrically conductive ceramic material, an electrically conductive composite material, and a combination thereof.

According to another aspect of the present invention, there is provided a portable hand holdable electric cigarette lighter, comprising: (a) an electrical resistance heating element contactable by a cigarette, for lighting the cigarette; (b) a built-in internally located direct current power supply for supplying electrical power; (c) an electromechanical circuit operatively connected to the heating element and the power supply, for transmitting the electrical power from the power supply to the heating element for the lighting; and (d) a portable hand holdable housing for housing the heating element, the power supply, and the electromechanical circuit.

According to further characteristics in this aspect of the portable hand holdable electric cigarette lighter described below, the heating element is supported by non-conductive support elements which are part of or attached to the portable hand holdable housing.

According to further characteristics in this aspect of the portable hand holdable electric cigarette lighter described below, the electromechanical circuit includes an actuating mechanism which actuates heating of the heating element.

According to further characteristics in this aspect of the portable hand holdable electric cigarette lighter described below, the actuating mechanism is a finger activatable/thermally responsive finger deactivatable electromechanical mechanism, activated by press of a finger and deactivated by release of the pressed finger in response to visual detection of an increase in temperature of the heating element to a cigarette lighting temperature of at least about 500° C.

According to further characteristics in this aspect of the portable hand holdable electric cigarette lighter described below, the actuating mechanism includes (1) a double-pole contactor switch assembly, and (2) a finger pressible/releasable rod or bar assembly.

According to further characteristics in this aspect of the portable hand holdable electric cigarette lighter described below, the actuating mechanism is a finger activatable/thermally responsive automatically deactivatable electromechanical mechanism, activated by press of a finger and automatically deactivated in response to an increase in temperature of the heating element to a pre-determined threshold cigarette lighting temperature of at least about 500° C.

According to further characteristics in this aspect of the portable hand holdable electric cigarette lighter described below, the actuating mechanism includes (1) a finger pressible and removable contacting assembly, contactable with (2) an automatic thermally expandable and releasable contacting assembly.

According to further characteristics in this aspect of the portable hand holdable electric cigarette lighter described below, the finger pressible removable contacting assembly includes a longitudinally movable inner assembly having a first end portion positioned inside of a longitudinally movable outer assembly.

According to further characteristics in this aspect of the portable hand holdable electric cigarette lighter described below, the internal direct current power supplies the electrical power having a voltage in a range of between about 0.5 volts and about 25 volts, for heating the heating element to a cigarette lighting temperature at least about 500° C.

According to further characteristics in this aspect of the portable hand holdable electric cigarette lighter described below, the internal direct current power supply is selected from the group consisting of one or more disposable batteries, one or more rechargeable batteries, and an electromagnetic direct current generator.

According to further characteristics in this aspect of the portable hand holdable electric cigarette lighter described below, the internal direct current power supply is one or more disposable batteries.

According to further characteristics in this aspect of the portable hand holdable electric cigarette lighter described below, the internal direct current power supply is one or more rechargeable batteries, and the electromechanical circuit additionally includes a battery recharging control unit operatively connected to the one or more rechargeable batteries.

According to further characteristics in this aspect of the portable hand holdable electric cigarette lighter described below, the battery recharging control unit is operatively connectable to an externally located battery recharging device.

According to further characteristics in this aspect of the portable hand holdable electric cigarette lighter described below, the internal direct current power supply is one or more rechargeable batteries, and the electromechanical circuit additionally includes a combination of a battery recharging control unit and a battery recharging device operatively connected to the one or more rechargeable batteries.

According to further characteristics in this aspect of the portable hand holdable electric cigarette lighter described below, the combination of a battery recharging control unit and a battery recharging device is operatively connectable to an externally located alternating current power supply.

According to further characteristics in this aspect of the portable hand holdable electric cigarette lighter described below, the internal direct current power supply is an electromagnetic direct current generator.

According to further characteristics in this aspect of the portable hand holdable electric cigarette lighter described below, the internal direct current power supply is an electromagnetic direct current generator, and the electromechanical circuit additionally includes an electromagnetic direct current generator control unit operatively connected to the electromagnetic direct current generator.

According to further characteristics in this aspect of the portable hand holdable electric cigarette lighter described below, the electromagnetic direct current generator control unit is operatively connectable to an externally located alternating current power supply.

According to further characteristics in this aspect of the portable hand holdable electric cigarette lighter described below, the ranges of values of geometrical dimensions of length, height, and width or depth, of the portable hand holdable housing are between about 1 cm and about 6 cm, between about 5 cm and about 12 cm, and between about 0.5 cm and about 5 cm, respectively.

According to further characteristics in this aspect of the portable hand holdable electric cigarette lighter described below, the values of geometrical dimensions of length, height, and width or depth, of the portable hand holdable housing are about 3 cm, about 8 cm, and about 1.5 cm, respectively.

According to further characteristics in this aspect of the portable hand holdable electric cigarette lighter described below, the heating element receives and handles a voltage of between about 0.5 volts and about 25 volts, and a current of up to about 10 amps.

According to further characteristics in this aspect of the portable hand holdable electric cigarette lighter described below, the heating element is stable when heated to a temperature of at least about 500° C. within a time span of less than about one minute.

According to further characteristics in this aspect of the portable hand holdable electric cigarette lighter described below, the heating element is made of a material selected from the group consisting of a pure metal, a metal alloy of at least two pure metals, an electrically conductive graphite material, an electrically conductive ceramic material, an electrically conductive composite material, and a combination thereof.

### BRIEF DESCRIPTION OF THE DRAWINGS

The present invention is herein described, by way of example only, with reference to the accompanying drawings. With specific reference now to the drawings in detail, it is stressed that the particulars shown are by way of example and for purposes of illustrative description of the preferred embodiments of the present invention only, and are presented in the cause of providing what is believed to be the most useful and readily understood description of the principles and conceptual aspects of the present invention. In this regard, no attempt is made to show structural details of the present invention in more detail than is necessary for a fundamental understanding of the invention, the description taken with the drawings making apparent to those skilled in the art how the several forms of the invention may be embodied in practice. In the drawings:

FIG. 1 is a schematic diagram illustrating an open (front, back, or in between) side view of the first exemplary specific configuration of the first preferred embodiment of the portable hand holdable electric cigarette lighter, wherein the electromechanical circuit for heating of the heating element is supplied electrical power from an externally located alternating current (ac) power supply, and the actuating mechanism is a finger activatable/thermally responsive finger deactivatable electromechanical mechanism, for lighting a cigarette or cigar, in accordance with the present invention;

FIG. 2 is a schematic diagram illustrating an open (front, back, or in between) side view of the second exemplary specific configuration of the first preferred embodiment of the portable hand holdable electric cigarette lighter, wherein the electromechanical circuit for heating of the heating element is supplied electrical power from an externally located alternating current (ac) power supply, and the actuating mechanism is a finger activatable/thermally responsive automatically deactivatable electromechanical mechanism, for lighting a cigarette or cigar, in accordance with the present invention;

FIG. 3 is a schematic diagram illustrating an open (front, back, or in between) side view of the first exemplary specific configuration, and alternative configurations thereof, of the second preferred embodiment of the portable hand holdable electric cigarette lighter, wherein the electromechanical circuit for heating of the heating element is supplied electrical power from a built-in internally located direct current (dc) power supply, and the actuating mechanism is a finger activatable/thermally responsive finger deactivatable electromechanical mechanism, for lighting a cigarette or cigar, in accordance with the present invention; and

FIG. 4 is a schematic diagram illustrating an open (front, back, or in between) side view of the second exemplary specific configuration, and alternative configurations thereof, of the second preferred embodiment of the portable hand holdable electric cigarette lighter, wherein the electromechanical circuit for heating of the heating element is supplied electrical power from a built-in internally located direct current (dc) power supply, and the actuating mechanism is a finger activatable/thermally responsive automatically deactivatable electromechanical mechanism, for lighting a cigarette or cigar, in accordance with the present invention.

### DESCRIPTION OF THE PREFERRED EMBODIMENTS

The present invention relates to a portable hand holdable electric cigarette lighter which is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by an individual, ready for immediate and routine use for lighting a cigarette or cigar. The portable hand holdable electric cigarette lighter includes an electrical resistance heating element contactable by a cigarette, for lighting the cigarette, and operatively connected to an electromechanical circuit which is supplied electrical power either from an externally located alternating current (ac) power supply, or from a built-in internally located direct current (dc) power supply. The portable hand holdable electric cigarette lighter includes a portable hand holdable housing for housing the components therein, in a fully operable configuration.

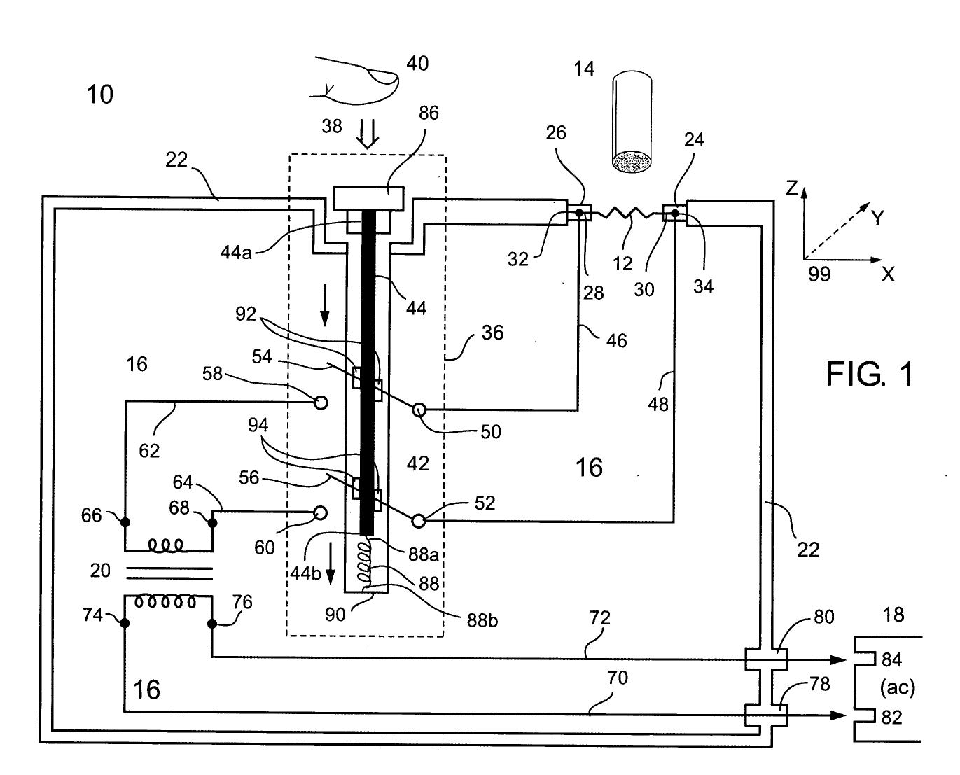

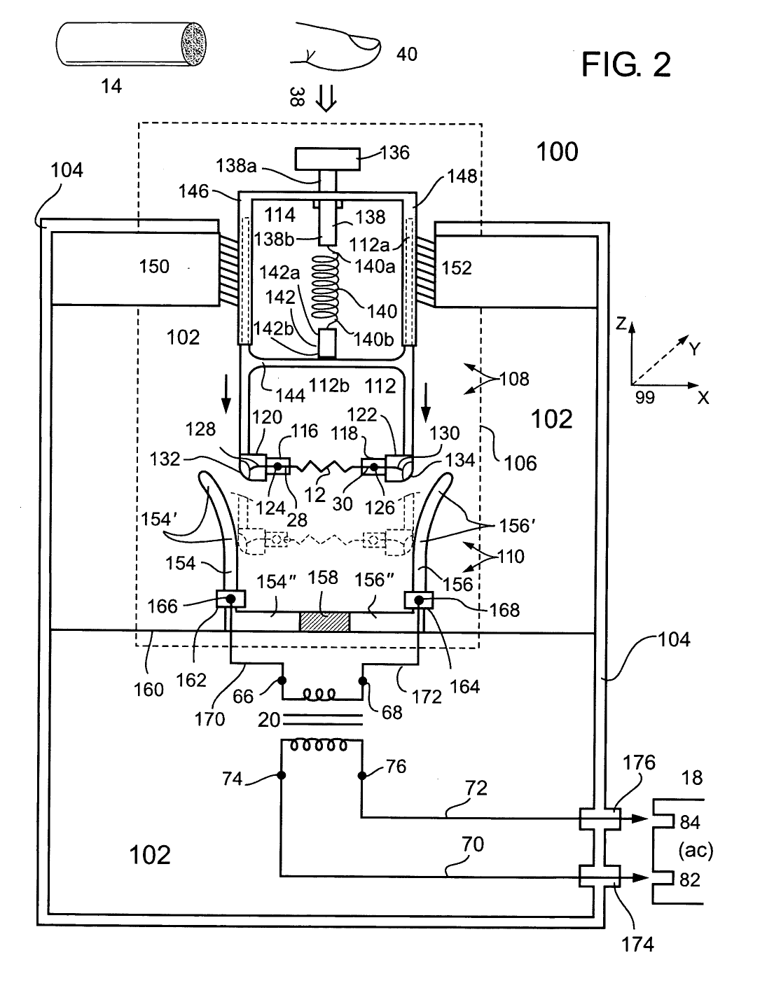

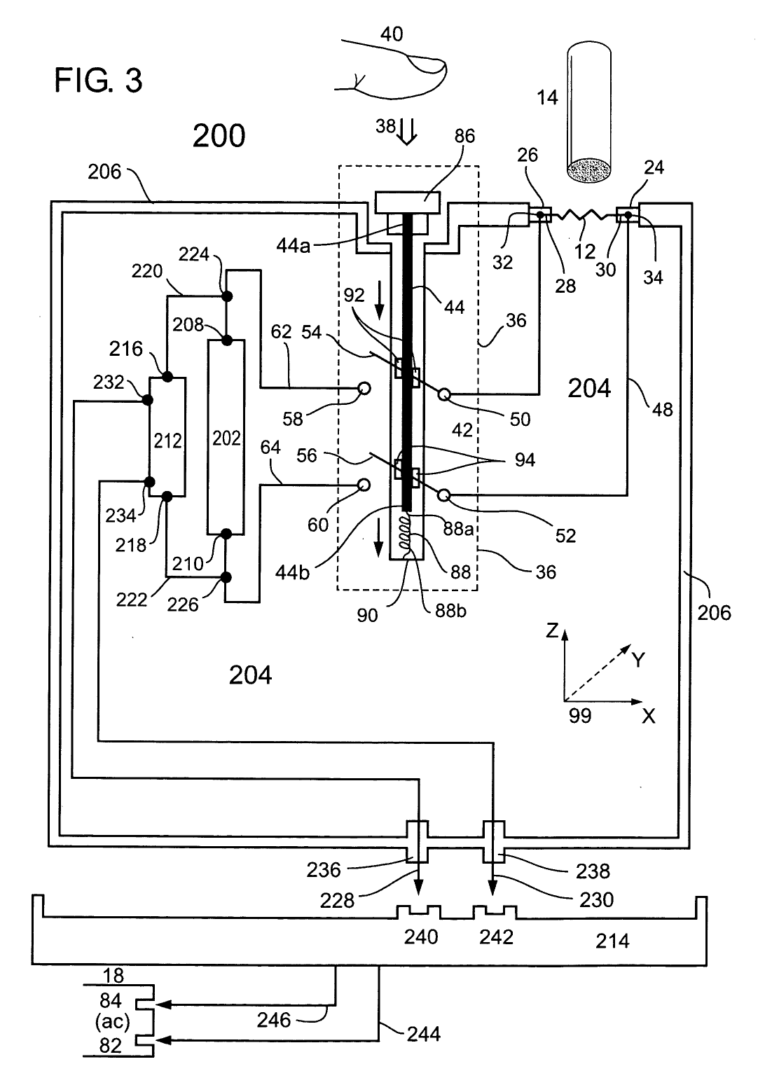

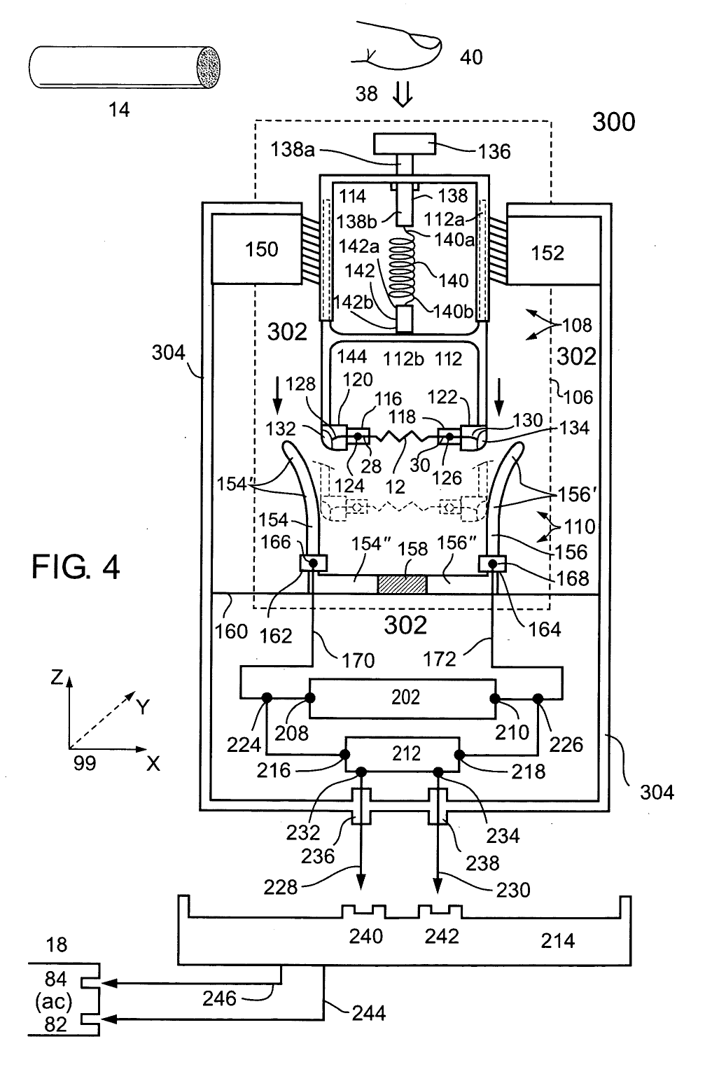

The first preferred embodiment of the portable hand holdable electric cigarette lighter of the present invention, described hereinbelow and illustrated in FIGS. 1 and 2, features a specific physical and spatial layout or configuration, and geometrical dimensions, particularly ready for use when located on top of an article of furniture (for example, a desk or drawer unit) or a shelf, or directly plugged into a wall electrical outlet or other suitable electrical outlet. The second preferred embodiment of the portable hand holdable electric cigarette lighter of the present invention, described hereinbelow and illustrated in FIGS. 3 and 4, features a specific physical and spatial layout or configuration, and geometrical dimensions, particularly ready for use when being carried and moved around, for example, in a clothes pocket, purse, or small bag, but is also ready for use when located on top of an article of furniture or a shelf.

In the first preferred embodiment of the portable hand holdable electric cigarette lighter of the present invention, the electromechanical circuit is operatively connected to the electrical resistance heating element and connectable to an externally located alternating current power supply providing a primary voltage of about 110 volts or about 220 volts. The electromechanical circuit includes a step-down voltage transformer for transforming the primary voltage to a secondary voltage in a range of between about 0.5 volts and about 25 volts, such that the electromechanical circuit transmits electrical power having the secondary voltage to the heating element for lighting the cigarette or cigar. The first preferred embodiment of the portable hand holdable electric cigarette lighter also includes a portable hand holdable housing for housing the heating element and the electromechanical circuit in a fully operable configuration.

In the second preferred embodiment of the portable hand holdable electric cigarette lighter of the present invention, the electromechanical circuit is operatively connected to the electrical resistance heating element and to a built-in internally located direct current power supply, for example, one or more disposable or rechargeable batteries, or an electromagnetic direct current (dc) generator, for transmitting electrical power from the power supply to the heating element for lighting the cigarette or cigar. The second preferred embodiment of the portable hand holdable electric cigarette lighter also includes a portable hand holdable housing for housing the heating element, the power supply, and the electromechanical circuit in a fully operable configuration.

In each of the first and second preferred embodiments of the portable hand holdable electric cigarette lighter of the present invention, the electromechanical circuit includes an actuating mechanism which actuates heating of the heating element for lighting the cigarette or cigar.

In a first exemplary specific configuration, and alternative configurations thereof, of each of the first and second preferred embodiments of the portable hand holdable electric cigarette lighter of the present invention, the actuating mechanism is a finger activatable/thermally responsive finger deactivatable electromechanical mechanism, which is activated by the press or push of a finger and deactivated by release of the pressed or pushed finger in response to visual detection of an increase in temperature of the heating element to a desired cigarette or cigar lighting temperature, preferably, at least about 500° C. This type of electromechanical mechanism includes (1) a double-pole contactor switch assembly electromechanically connected to the conductive ends of the heating element and electromechanically connectable to part of the electromechanical circuit that transmits the necessary electrical power (ac or dc) from the power supply, and (2) a finger pressible/releasable rod or bar assembly mechanically connected to the poles of the double-pole contactor switch assembly.

In a second exemplary specific configuration, and alternative configurations thereof, of each of the first and second preferred embodiments of the portable hand holdable electric cigarette lighter of the present invention, the actuating mechanism is a finger activatable/thermally responsive automatically deactivatable electromechanical mechanism, which is activated by the press or push of a finger and automatically deactivated in response to an increase in temperature of the heating element to a pre-determined threshold temperature, preferably, at least about 500° C., sufficient for lighting the cigarette or cigar. This type of electromechanical mechanism includes (1) a finger pressible removable contacting assembly contactable with (2) an automatic thermally expandable and releasable contacting assembly.

A main aspect of novelty and inventiveness of the portable hand holdable electric cigarette lighter of the present invention is the combination of being (1) portable, (2) hand holdable, and (3) hand operable. The portable hand holdable electric cigarette lighter of the present invention is of a portable, hand holdable, and hand operable, configuration, ready for immediate and routine use for lighting a cigarette or cigar. By housing an appropriate combination of electromechanical components of the portable hand holdable electric cigarette lighter, which are needed for immediate use of lighting a cigarette or cigar, in a fully operable configuration within a portable hand holdable housing, the portable hand holdable electric cigarette lighter is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by an individual, ready for immediate and routine use for lighting a cigarette or cigar.

It is to be understood that the present invention is not limited in its application to the details of type, composition, construction, arrangement, order, and number, of the mechanisms, assemblies, components, elements, and materials, of the portable hand holdable electric cigarette lighter set forth in the following description and accompanying drawings. For example, the following description includes illustrative detail of two exemplary specific configurations, and alternative configurations thereof, of each of a first and second preferred embodiment of the portable hand holdable electric cigarette lighter of the present invention, corresponding to the electromechanical circuit including either of two exemplary specific types of a finger activatable actuating mechanism which actuates heating of the heating element for lighting the cigarette or cigar, in order to illustrate implementation of the present invention. Moreover, for each exemplary specific configuration, and alternative configurations thereof, the following description includes reference to various different electrical, electronic, mechanical, and electromechanical, devices, mechanisms, assemblies, components, and elements.

Furthermore, the scope of the present invention encompasses portable hand holdable electric lighting devices which are specifically designed, constructed, and used, for lighting cigarettes or cigars. Herein, for purposes of brevity and maintaining clarity of description, while not unnecessarily limiting generality of scope and applicability of the invention, the work pieces of the invention being cigarettes or cigars, are generally and equivalently referred to as cigarettes. Accordingly, it is to be understood, that the present invention, although ‘literally’ directed to and focused on a portable hand holdable electric ‘cigarette’ lighter, is clearly and fully applicable for functioning as a portable hand holdable electric ‘cigar’ lighter, and occasional reference is appropriately made to such applicability in the present disclosure.

Accordingly, the present invention is capable of other embodiments and of being practiced or carried out in various ways. Although mechanisms, assemblies, components, elements, and materials, similar or equivalent to those described herein can be used for practicing or testing the present invention, suitable mechanisms, assemblies, components, elements, and materials, are described herein.

It is also to be understood that unless otherwise defined, all technical and scientific words, terms, and/or phrases, used herein have either the identical or similar meaning as commonly understood by one of ordinary skill in the art to which this invention belongs. Phraseology, terminology, and, notation, employed herein are for the purpose of description and should not be regarded as limiting. For example, in the following description, it is to be fully understood that the terms ‘connectable’, ‘connected’, and ‘connecting’, are generally used herein, and also may refer to the corresponding synonymous terms ‘joinable’, ‘joined’, and ‘joining’, as well as ‘attachable’, ‘attached’, and ‘attaching’. Additionally, as used herein, the term ‘about’ refers to ±10% of the associated value.

Herein, the phrase ‘portable hand holdable’, used for defining and characterizing the electric cigarette lighter of the present invention, refers to the capability of the electric cigarette lighter to be relatively easily held, operated, carried, and moved around, by one or two hands of an individual, ready for immediate and routine use for lighting a cigarette or cigar. More specifically, the portable hand holdable electric cigarette lighter is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by one or two hands of an individual, ready for immediate and routine use for lighting a cigarette or cigar.

Herein, the phrase ‘electromechanical circuit’ refers to an operable configuration or physical and spatial layout, of a combination of electrically, electronically, electromagnetically, mechanically, and/or electromechanically, connected and/or connectable, and, operable and/or potentially operable, devices, mechanisms, assemblies, components, and/or elements. In the electromechanical circuit, any number of the devices, mechanisms, assemblies, components, and/or elements, are either in an operative condition or in a potentially operative condition, according to the instantaneous flow or potential flow of electrical power through at least part of the electromechanical circuit at a given moment in time.

Components, elements, operation, implementation, of preferred embodiments, alternative embodiments, specific configurations and alternative configurations thereof, and optional aspects, characteristics, or features, thereof, of a portable hand holdable electric cigarette lighter, according to the present invention, are better understood with reference to the following description and accompanying drawings. Throughout the following description and accompanying drawings, same reference numbers refer to same devices, mechanisms, assemblies, components, or elements.

In the following description of the present invention, included are main or principal devices, mechanisms, assemblies, components, and elements, and functions thereof, needed for sufficiently understanding proper ‘enabling’ utilization and implementation of the disclosed portable hand holdable electric cigarette lighter. Accordingly, descriptions of various possible required and/or optional preliminary, intermediate, minor, electrical, electronic, electromagnetic, mechanical, and/or electromechanical, devices, mechanisms, assemblies, components, and/or elements, and/or functions thereof, which are readily known by one of ordinary skill in the art, and/or which are available in the prior art and technical literature, are at most only briefly indicated herein.

Immediately following there is provided illustrative description of the two exemplary specific configurations, and alternative configurations thereof, of the first preferred embodiment of the portable hand holdable electric cigarette lighter of the present invention, wherein the electromechanical circuit is supplied electrical power from an externally located alternating current (ac) power supply. The two exemplary specific configurations of the first preferred embodiment of the portable hand holdable electric cigarette lighter differ according to the type of actuating mechanism, included in the electromechanical circuit, which actuates heating of the heating element for lighting the cigarette or cigar.

Thereafter, is provided illustrative description of the two exemplary specific configurations, and alternative configurations thereof, of the second preferred embodiment of the portable hand holdable electric cigarette lighter of the present invention, wherein the electromechanical circuit is supplied electrical power from a built-in internally located direct current (dc) power supply. As for the two exemplary specific configurations of the first preferred embodiment of the portable hand holdable electric cigarette lighter, the two exemplary specific configurations of the second preferred embodiment of the portable hand holdable electric cigarette lighter similarly differ in the same manner according to the type of actuating mechanism, included in the electromechanical circuit, which actuates heating of the heating element for lighting the cigarette or cigar.

In each exemplary specific configuration, and alternative configurations thereof, of each of the first and second preferred embodiments of the portable hand holdable electric cigarette lighter, a portable hand holdable housing is included for housing the components therein, in a fully operable configuration, ready for immediate and routine use for lighting a cigarette or cigar.

Referring now to the drawings, FIG. 1 is a schematic diagram illustrating an open (front, back, or in between) side view of the first exemplary specific configuration of the first preferred embodiment of the portable hand holdable electric cigarette lighter, wherein the electromechanical circuit for heating of the heating element is supplied electrical power from an externally located alternating current (ac) power supply, and the actuating mechanism is a finger activatable/thermally responsive finger deactivatable electromechanical mechanism, for lighting a cigarette or cigar.

As shown in FIG. 1, the first exemplary specific configuration of the first preferred embodiment of the portable hand holdable electric cigarette lighter, hereinafter, referred to as portable hand holdable electric cigarette lighter 10, of the present invention, includes the following main components and functions thereof: (a) an electrical resistance heating element 12 contactable by a cigarette or cigar 14, hereinafter, equivalently referred to as cigarette 14, for lighting the cigarette 14, (b) an electromechanical circuit 16 operatively connected to the heating element 12 and connectable to an externally located alternating current (ac) power supply 18 providing a primary voltage of about 10 volts or about 220 volts, wherein the electromechanical circuit 16 includes a step-down voltage transformer 20 for transforming the primary voltage to a secondary voltage in a range of between about 0.5 volts and about 25 volts, such that the electromechanical circuit 16 transmits electrical power having the secondary voltage to the heating element 12 for lighting the cigarette 14, and (c) a portable hand holdable housing 22 for housing the heating element 12 and the electromechanical circuit 16 in a fully operable configuration.

Portable hand holdable electric cigarette lighter 10, as illustrated in FIG. 1, features a specific physical and spatial layout or configuration, and geometrical dimensions, particularly ready for use when located on top of an article of furniture (for example, a desk or drawer unit) or a shelf, or directly plugged into a wall electrical outlet or other suitable electrical outlet.

In portable hand holdable electric cigarette lighter 10, electrical resistance heating element 12, hereinafter, equivalently referred to as heating element 12, is firmly supported and held by non-conductive support elements 24 and 26 which are either part of, or attached to, portable hand holdable housing 22. Conductive ends 28 and 30 of heating element 12 are connected to conductive contact points 32 and 34, respectively, located along the sides or inside of support elements 24 and 26, respectively.

As stated immediately above, electromechanical circuit 16 is operatively connected to heating element 12 and connectable to externally located alternating current (ac) power supply 18, hereinafter, equivalently referred to as external (ac) power supply 18, providing a primary voltage of about 110 volts or about 220 volts, wherein electromechanical circuit 16 includes step-down voltage transformer 20 for transforming the primary voltage to a secondary voltage in a range of between about 0.5 volts and about 25 volts, such that electromechanical circuit 16 transmits electrical power having the secondary voltage to heating element 12 for lighting cigarette 14.

Electromechanical circuit 16, hereinafter, generally referred to as electromechanical circuit 16, is an electromechanical circuit as generally defined hereinabove, that includes electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 22, which are applicable for transmitting the secondary voltage of between about 0.5 volts and about 25 volts supplied by step-down voltage transformer 20 to heating element 12, for lighting cigarette 14.

In addition to step-down voltage transformer 20, electromechanical circuit 16 includes an actuating mechanism 36 (indicated in FIG. 1 by the dashed line rectangle) which actuates heating of heating element 12 for lighting cigarette 14. Actuating mechanism 36 is a finger activatable/thermally responsive finger deactivatable electromechanical mechanism, which is activated by the press or push (indicated in FIG. 1 by arrow 38) of a finger 40 and deactivated by release of the pressed or pushed finger 40 in response to visual detection of an increase in temperature of heating element 12 to a desired cigarette lighting temperature, preferably, at least about 500° C. Actuating mechanism 36 includes (1) a double-pole contactor switch assembly 42, hereinafter, equivalently referred to as switch assembly 42, and (2) a finger pressible/releasable rod or bar assembly 44, hereinafter, equivalently referred to as rod assembly 44.

In actuating mechanism 36 of electromechanical circuit 16, wires or leads 46 and 48 leading from conductive contact points 32 and 34, respectively, of heating element 12, are connected to a first pair of conductive contact points 50 and 52, respectively, of switch assembly 42. The two poles 54 and 56 of switch assembly 42 are movably connected to first pair of conductive contact points 50 and 52, respectively, of switch assembly 42, and are movably connectable to a second pair of conductive contact points 58 and 60, respectively, of switch assembly 42. Wires or leads 62 and 64 leading from second pair of conductive contact points 58 and 60, respectively, of switch assembly 42, are connected to a pair of output conductive contact points 66 and 68, respectively, of step-down voltage transformer 20. Wires or leads 70 and 72 leading from a pair of input conductive contact points 74 and 76, respectively, of step-down voltage transformer 20, and passing through ports or openings 78 and 80, respectively, of portable hand holdable housing 22, are operatively connectable to electrical sockets 82 and 84, respectively, of externally located alternating current (ac) power supply 18.

For this exemplary specific configuration, in actuating mechanism 36, the first end 44a, that is, the finger pressible/releasable end, of rod assembly 44, either includes or is connected to, a finger pressible/releasable element 86, in particular, a button or knob, and the second end 44b of rod assembly 44 is connected to the first end 88a of an elastic (compressible/decompressible) element 88, for example, a spring, whose second end 88b is fixed, in particular, to an inside wall 90 of portable hand holdable housing 22. The two poles 54 and 56 of switch assembly 42 are movably connected, via connecting elements 92 and 94, respectively, to rod assembly 44.

As illustrated in FIG. 1, in portable hand holdable electric cigarette lighter 10, finger pressible/releasable element (button or knob) 86 of rod assembly 44 and heating element 12 are each located along the top side of portable hand holdable housing 22, facing the upward direction, providing for convenient activation of actuating mechanism 36 and lighting of cigarette 14, especially for situations where portable hand holdable electric cigarette lighter 10, configured as shown in FIG. 1, is located on top of an article of furniture (for example, a desk or drawer unit) or a shelf, or plugged directly into a wall electrical outlet or other suitable electrical outlet. Moreover, configured as shown in FIG. 1, actuating mechanism 36 of electromechanical circuit 16 is mostly located in the middle portion, step-down voltage transformer 20 of electromechanical circuit 16 is mostly located in the lower left side portion, and ports or openings 78 and 80 are located along the bottom right side, of portable hand holdable housing 22.

As previously stated, portable hand holdable electric cigarette lighter 10, as illustrated in FIG. 1, features a specific physical and spatial layout or configuration, and geometrical dimensions, ready for use preferably when located on top of an article of furniture (for example, a desk or drawer unit) or a shelf, or directly plugged into a wall electrical outlet or other suitable electrical outlet. With reference to reference xyz-coordinate system 99 shown in FIG. 1, whereby the xz-plane corresponds to the plane of the paper, and the y-axis is perpendicular thereof, preferred ranges of values and preferred values of geometrical dimensions (length, height, and width or depth) of portable hand holdable housing 22 are as follows. Value of length, along the x-axis, is preferably in a range of between about 5 cm and about 20 cm, and is preferably about 14 cm. Value of height, along the z-axis, is preferably in a range of between about 4 cm and about 15 cm, and is preferably about 8 cm. Value of width or depth, along the y-axis, is preferably in a range of between about 5 cm and about 15 cm, and is preferably about 10 cm.

In general, function and operation of portable hand holdable electric cigarette lighter 10, and devices, mechanisms, assemblies, components, and/or elements, therein, are not limited to the exemplary specific physical and spatial layout or configuration, and relative geometrical dimensions, illustrated in FIG. 1, or to the just stated exemplary preferred ranges of values and values of geometrical dimensions (length, height, and width or depth). Accordingly, the specific physical and spatial layout or configuration, and geometrical dimensions, of the devices, mechanisms, assemblies, components, and/or elements, such as finger pressible/releasable element (button or knob) 86 of rod assembly 44, heating element 12, actuating mechanism 36, step-down voltage transformer 20, and ports or openings 78 and 80, of portable hand holdable electric cigarette lighter 10, inside and along the sides of portable hand holdable housing 22, is clearly variable.

For operating portable hand holdable electric cigarette lighter 10, a user selects a suitable externally located alternating current (ac) power supply 18, typically, in a wall, providing a primary voltage of about 110 volts or about 220 volts, and plugs wires or leads 70 and 72 leading from input conductive contact points 74 and 76, respectively, of step-down voltage transformer 20, and passing through ports or openings 78 and 80, respectively, of portable hand holdable housing 22, into electrical sockets 82 and 84, respectively, of externally located alternating current (ac) power supply 18. The user activates actuating mechanism 36 of electromechanical circuit 16 by pressing or pushing (arrow 38) finger 40 against finger pressible/releasable element (button or knob) 86 of finger pressible/releasable rod assembly 44, and continues to hold finger pressible/releasable element 86 in the pressed or pushed condition, whereupon rod assembly 44 longitudinally moves and elastic (compressible/decompressible) element (spring) 88 compresses, towards inside wall 90 of portable hand holdable housing 22 (indicated in FIG. 1 by the filled-in head arrows parallel to rod assembly 44).

This action causes the initially unconnected ends of poles 54 and 56 of switch assembly 42 to longitudinally move towards, and become connected to, contact points 58 and 60, thereby putting switch assembly 42 and electromechanical circuit 16 in a closed and actuated state. Step-down voltage transformer 20 transforms the primary voltage of about 110 volts or about 220 volts received from (ac) power supply 18, to a secondary voltage in a range of between about 0.5 volts and about 25 volts. The user continues to hold finger pressible/releasable element 86 in the pressed or pushed condition, while electromechanical circuit 16 transmits, via above illustratively described electrically conductive paths and contact points, the electrical power having the secondary voltage to heating element 12, until heating element 12 becoming heated to a sufficiently high temperature, preferably, at least about 500° C., for lighting cigarette 14.

Immediately upon visually detecting that heating element 12 reaches a sufficiently high temperature for lighting cigarette 14, for example, wherein heating element 12 emits a red hot glow, the user continues to hold finger pressible/releasable element 86 in the pressed or pushed condition, while lighting cigarette 14. Immediately after lighting cigarette 14, the user discontinues to hold and releases finger pressible/releasable element 86, whereupon rod assembly 44 longitudinally moves back to its initial position and elastic (compressible/decompressible) element (spring) 88 decompresses away from inside wall 90 of portable hand holdable housing 22. This action causes the connected ends of poles 54 and 56 of switch assembly 42 to become disconnected and longitudinally move away from contact points 58 and 60, thereby returning switch assembly 42 and electromechanical circuit 16 to an open and non-actuated state.

Alternatively, immediately upon visually detecting that heating element 12 reaches a sufficiently high temperature for lighting cigarette 14, just prior to lighting cigarette 14, the user discontinues to hold and releases finger pressible/releasable element 86, and then immediately lights cigarette 14. In this case, by the time the user has completed lighting cigarette 14, rod assembly 44 has already longitudinally moved back to its initial position and elastic (compressible/decompressible) element (spring) 88 has already decompressed away from inside wall 90 of portable hand holdable housing 22, whereupon the connected ends of poles 54 and 56 of switch assembly 42 have already become disconnected and longitudinally moved away from contact points 58 and 60, thereby having returned switch assembly 42 and electromechanical circuit 16 to an open and non-actuated state.

Following operation of portable hand holdable electric cigarette lighter 10 for lighting cigarette 14, the user leaves wires or leads 70 and 72 leading from step-down voltage transformer 20 plugged into electrical sockets 82 and 84, respectively, of (ac) power supply 18, thereby leaving portable hand holdable electric cigarette lighter 10 in a fully operable configuration, again ready for immediate and routine use for lighting cigarette 14. Alternatively, the user unplugs wires or leads 70 and 72 from electrical sockets 82 and 84, respectively, of (ac) power supply 18, for enabling portable use of portable hand holdable electric cigarette lighter 10 for lighting cigarette 14, for example, by carrying and moving portable hand holdable electric cigarette lighter 10 to another location having a suitable externally located alternating current (ac) power supply 18, providing a primary voltage of about 110 volts or about 220 volts, again ready for immediate and routine use for lighting cigarette 14.

FIG. 2 is a schematic diagram illustrating an open (front, back, or in between) side view of the second exemplary specific configuration of the first preferred embodiment of the portable hand holdable electric cigarette lighter, wherein the electromechanical circuit for heating of the heating element is supplied electrical power from an externally located alternating current (ac) power supply, and the actuating mechanism is a finger activatable/thermally responsive automatically deactivatable electromechanical mechanism, for lighting a cigarette or cigar.

As shown in FIG. 2, the second exemplary specific configuration of the first preferred embodiment of the portable hand holdable electric cigarette lighter, hereinafter, referred to as portable hand holdable electric cigarette lighter 100, of the present invention, includes the following main components and functions thereof: (a) an electrical resistance heating element 12 contactable by a cigarette or cigar 14, hereinafter, equivalently referred to as cigarette 14, for lighting the cigarette 14, (b) an electromechanical circuit 102 operatively connected to the heating element 12 and connectable to an externally located alternating current (ac) power supply 18 providing a primary voltage of about 10 volts or about 220 volts, wherein the electromechanical circuit 102 includes a step-down voltage transformer 20 for transforming the primary voltage to a secondary voltage in a range of between about 0.5 volts and about 25 volts, such that the electromechanical circuit 102 transmits electrical power having the secondary voltage to the heating element 12 for lighting the cigarette 14, and (c) a portable hand holdable housing 104 for housing the heating element 12 and the electromechanical circuit 102 in a fully operable configuration.

Portable hand holdable electric cigarette lighter 100, as illustrated in FIG. 2, features a specific physical and spatial layout or configuration, and geometrical dimensions, particularly ready for use when located on top of an article of furniture (for example, a desk or drawer unit) or a shelf, or directly plugged into a wall electrical outlet or other suitable electrical outlet.

In portable hand holdable electric cigarette lighter 100, electrical resistance heating element 12, hereinafter, equivalently referred to as heating element 12, is firmly supported and held by non-conductive support elements 116 and 118 which are either part of, or attached to, end elements 120 and 122, respectively, of a longitudinally extendable inner assembly 112 of actuating mechanism 106 of electromechanical circuit 102. Conductive ends 28 and 30 of heating element 12 are connected to thermally conductive contact points 124 and 126, respectively, located along the sides or inside of support elements 116 and 118, respectively.

As stated immediately above, electromechanical circuit 102 is operatively connected to heating element 12 and connectable to externally located alternating current (ac) power supply 18 providing a primary voltage of about 110 volts or about 220 volts, wherein electromechanical circuit 102 includes step-down voltage transformer 20 for transforming the primary voltage to a secondary voltage in a range of between about 0.5 volts and about 25 volts, such that electromechanical circuit 102 transmits electrical power having the secondary voltage to heating element 12 for lighting cigarette 14.

Electromechanical circuit 102, hereinafter, generally referred to as electromechanical circuit 102, is an electromechanical circuit as generally defined hereinabove, that includes electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 104, which are applicable for transmitting the secondary voltage of between about 0.5 volts and about 25 volts supplied by step-down voltage transformer 20 to heating element 12, for lighting cigarette 14.

In addition to step-down voltage transformer 20, electromechanical circuit 102 includes an actuating mechanism 106 (indicated in FIG. 2 by the dashed line rectangle) which actuates heating of heating element 12 for lighting cigarette 14. Actuating mechanism 106 is a finger activatable/thermally responsive automatically deactivatable electromechanical mechanism, which is activated by the press or push (indicated in FIG. 2 by arrow 38) of a finger 40 and automatically deactivated in response to an increase in temperature of heating element 12 to a pre-determined threshold temperature, preferably least about 500° C., sufficient for lighting cigarette 14. This type of electromechanical mechanism includes (1) a finger pressible and removable contacting assembly 108, hereinafter, equivalently referred to as removable contacting assembly 108, contactable with (2) an automatic thermally expandable and releasable contacting assembly 110, hereinafter, equivalently referred to as releasable contacting assembly 110.

In actuating mechanism 106 of electromechanical circuit 102, finger pressible removable contacting assembly 108 includes a longitudinally movable inner assembly 112, hereinafter, equivalently referred to as inner assembly 112, having a first end portion 112a positioned inside of a longitudinally movable outer assembly 114, hereinafter, equivalently referred to as outer assembly 114. Non-conductive support elements 116 and 118 which are either part of, or attached to, end elements 120 and 122, respectively, of the second end portion 112b of inner assembly 112, firmly support and hold heating element 12. Conductive ends 28 and 30 of heating element 12 are connected to conductive contact points 124 and 126, respectively, located along the sides or inside of support elements 116 and 118, respectively. Thermally conductive wires 128 and 130 leading from thermally conductive contact points 124 and 126, respectively, of heating element 12, are connected to thermally conductive contact elements 132 and 134, respectively, of end elements 120 and 122, respectively, of second end portion 112b of inner assembly 112.

Outer assembly 114 of removable contacting assembly 108 includes a finger pressible element 136, in particular, a button or knob, which is connected to the first end 138a of a longitudinally movable rod or bar 138. The second end 138b of rod or bar 138 is connected to the first end 140a of an elastic (compressible/decompressible) element 140, in particular, a spring. The second end 140b of elastic element 140 is connected to the first end 142a of a longitudinally movable connecting element 142 which is fixed to a support element 144 of inner assembly 112 extending across approximately the middle portion of inner assembly 112. The outer sides 146 and 148 of outer assembly 114 are movably supported or held by non-conductive elements 150 and 152, respectively, which are either included as part of, or connected to, the inside of the top portion of portable hand holdable housing 104.

In actuating mechanism 106, automatic thermally expandable and releasable contacting assembly 110 includes thermally expandable conductive elements 154 and 156. More specifically, following a relatively short period of time, for example, on the order of less than about one minute, preferably, less than about 30 seconds, and more preferably, less than about 5 seconds, of being in physical and thermal contact with thermally conductive contact elements 132 and 134 of end elements 120 and 122, respectively, of second end portion 112b of inner assembly 112, (indicated in FIG. 2 by the dashed lined ‘shadow’ of heating element 12 and selected components of second end portion 112b of inner assembly 112), for receiving heat generated by heating element 12 and transmitted along thermally conductive wires 128 and 130 and along thermally conductive contact elements 132 and 134, respectively, the first end and middle portions 154′ of thermally expandable conductive element 154, and, the first end and middle portions 156′ of thermally expandable conductive element 156, thermally outwardly expand in the direction toward the inside walls of the middle portion of portable hand holdable housing 104.

Second end portion 154″ of thermally expandable conductive element 154, and, second end portion 156″ of thermally expandable conductive element 156, are electrically separated or insulated from each other by a non-conductive electrical insulating element 158. Non-conductive electrical insulating element 158 and, the end portions 154″ and 156″ of thermally expandable conductive elements 154 and 156, respectively, are rigidly fixed to a non-conductive support element 160 extending across the inside walls of portable hand holdable housing 104.

Conductive elements 154 and 156 are connected to and supported by either conductive or non-conductive support elements 162 and 164, respectively. Located along the sides, or inside, of support elements 162 and 164 are conductive contact points 166 and 168, respectively. Wires or leads 170 and 172 leading from conductive contact points 166 and 168, respectively, of releasable contacting assembly 110, are connected to a pair of output conductive contact points 66 and 68, respectively, of step-down voltage transformer 20. Wires or leads 70 and 72 leading from a pair of input conductive contact points 74 and 76, respectively, of step-down voltage transformer 20, and passing through ports or openings 174 and 176, respectively, of portable hand holdable housing 104, are operatively connectable to electrical sockets 82 and 84, respectively, of externally located alternating current (ac) power supply 18.

As illustrated in FIG. 2, in portable hand holdable electric cigarette lighter 100, finger pressible element (button or knob) 136 of outer assembly 114 of removable contacting assembly 108, is located along the top side of portable hand holdable housing 104, facing the upward direction, providing for convenient activation of actuating mechanism 106 and lighting of cigarette 14, especially for situations where portable hand holdable electric cigarette lighter 100, configured as shown in FIG. 2, is located on top of an article of furniture (for example, a desk or drawer unit) or a shelf, or plugged directly into a wall electrical outlet or other suitable electrical outlet. Moreover, configured as shown in FIG. 2, actuating mechanism 106 of electromechanical circuit 102 is located in the upper middle portion, step-down voltage transformer 20 of electromechanical circuit 102 is located in the lower middle portion, and ports or openings 174 and 176, are located along the bottom right side, of portable hand holdable housing 104.

As previously stated, portable hand holdable electric cigarette lighter 100, as illustrated in FIG. 2, features a specific physical and spatial layout or configuration, and geometrical dimensions, ready for use preferably when located on top of an article of furniture (for example, a desk or drawer unit) or a shelf, or directly plugged into a wall electrical outlet or other suitable electrical outlet. With reference to reference xyz-coordinate system 99 shown in FIG. 2, whereby the xz-plane corresponds to the plane of the paper, and the y-axis is perpendicular thereof, preferred ranges of values and preferred values of geometrical dimensions (length, height, and width or depth) of portable hand holdable housing 104 are as follows. Value of length, along the x-axis, is preferably in a range of between about 5 cm and about 20 cm, and is preferably about 14 cm. Value of height, along the z-axis, is preferably in a range of between about 4 cm and about 15 cm, and is preferably about 8 cm. Value of width or depth, along the y-axis, is preferably in a range of between about 5 cm and about 15 cm, and is preferably about 10 cm.

In general, function and operation of portable hand holdable electric cigarette lighter 100, and devices, mechanisms, assemblies, components, and/or elements, therein, are not limited to the exemplary specific physical and spatial layout or configuration, and relative geometrical dimensions, illustrated in FIG. 2, or to the just stated exemplary preferred ranges of values and values of geometrical dimensions (length, height, and width or depth). Accordingly, the specific physical and spatial layout or configuration, and geometrical dimensions, of the devices, mechanisms, assemblies, components, and/or elements, such as finger pressible element (button or knob) 136 of outer assembly 114 of removable contacting assembly 108, actuating mechanism 106, step-down voltage transformer 20, and ports or openings 174 and 176 of portable hand holdable housing 104, inside and along the sides of portable hand holdable housing 104, is clearly variable.

For operating portable hand holdable electric cigarette lighter 100, a user activates actuating mechanism 106 of electromechanical circuit 102, by momentarily pressing or pushing (arrow 38) finger 40 against finger pressible element 136. Inner assembly 112 of removable contacting assembly 108 longitudinally moves (indicated in FIG. 2 by the filled-in head arrow on each outer side of second end portion 112b of inner assembly 112) towards and into the space between thermally expandable conductive elements 154 and 156 of automatic thermally expandable and releasable contacting assembly 110, until thermally conductive contact elements 132 and 134, of end elements 120 and 122, respectively, of second end portion 112b of inner assembly 112, become physically held by, and make thermal contact with, first end and middle portions 154′ of thermally expandable conductive element 154, and, first end and middle portions 156′ of thermally expandable conductive element 156, respectively (indicated in FIG. 2 by the dashed lined ‘shadow’ of heating element 12 and selected components of second end portion 112b of inner assembly 112). Following a relatively short period of time, for example, on the order of less than about one minute, preferably, less than about 30 seconds, and more preferably, less than about 5 seconds, of this physical and thermal contact, the heat generated by heating element 12 and transmitted along thermally conductive wires 128 and 130 and along thermally conductive contact elements 132 and 134, respectively, of end elements 120 and 122, respectively, of second end portion 112b of inner assembly 112, causes first end and middle portions 154′ of thermally expandable conductive element 154, and, first end and middle portions 156′ of thermally expandable conductive element 156, to thermally outwardly expand a relatively small distance, for example, on the order of about a few millimeters, in the direction toward the inner walls of the middle portion of portable hand holdable housing 104.

This thermally outward expansion of first end and middle portions 154′ of thermally expandable conductive element 154, and, first end and middle portions 156′ of thermally expandable conductive element 156, causes automatic thermally expandable and releasable contacting assembly 110 to automatically release thermally conductive contact elements 132 and 134 of end elements 120 and 122, respectively, of second end portion 112b of inner assembly 112, whereupon inner assembly 112 of finger pressible removable contacting assembly 108 automatically longitudinally springs and moves back to its original position relative to outer assembly 114, while heating element 12 remains heated at a sufficiently high temperature, preferably, at least about 500° C., for lighting cigarette 14.

Immediately upon seeing and/or hearing automatic release of finger pressible element (button or knob) 136 as a result of inner assembly 112 of finger pressible removable contacting assembly 108 having automatically longitudinally sprung and moved back to its original position relative to outer assembly 114, the user grasps finger pressible element 136, and for increased stability of removal and holding, may also grasp the outer sides 146 and 148 of outer assembly 114, and pulls removable contacting assembly 108 out of portable hand holdable housing 104. The user then lights cigarette 14 by bringing heating element 12, while still at a sufficiently high temperature for lighting cigarette 14, into contact with cigarette 14 until lit. Following completion of lighting cigarette 14, the user returns removable contacting assembly 108 back to its initial position inside of the top portion of portable hand holdable housing 104.

Following operation of portable hand holdable electric cigarette lighter 100 for lighting cigarette 14, the user leaves wires or leads 70 and 72 leading from step-down voltage transformer 20 plugged into electrical sockets 82 and 84, respectively, of (ac) power supply 18, thereby leaving portable hand holdable electric cigarette lighter 100 in a fully operable configuration, again ready for immediate and routine use for lighting cigarette 14. Alternatively, the user unplugs wires or leads 70 and 72 from electrical sockets 82 and 84, respectively, of (ac) power supply 18, for enabling portable use of portable hand holdable electric cigarette lighter 100 for lighting cigarette 14, for example, by carrying and moving portable hand holdable electric cigarette lighter 100 to another location having a suitable externally located alternating current (ac) power supply 18, providing a primary voltage of about 110 volts or about 220 volts, again ready for immediate and routine use for lighting cigarette 14.

FIG. 3 is a schematic diagram illustrating an open (front, back, or in between) side view of the first exemplary specific configuration, and alternative configurations thereof, of the second preferred embodiment of the portable hand holdable electric cigarette lighter, wherein the electromechanical circuit for heating of the heating element is supplied electrical power from a built-in internally located direct current (dc) power supply, and the actuating mechanism is a finger activatable/thermally responsive finger deactivatable electromechanical mechanism, for lighting a cigarette or cigar.

As shown in FIG. 3, the first exemplary specific configuration, and alternative configurations thereof, of the second preferred embodiment of the portable hand holdable electric cigarette lighter, hereinafter, referred to as portable hand holdable electric cigarette lighter 200, of the present invention, each includes the following main components and functions thereof: (a) an electrical resistance heating element 12 contactable by a cigarette or cigar 14, hereinafter, equivalently referred to as cigarette 14, for lighting the cigarette 14, (b) a built-in internally located direct current (dc) power supply 202 for supplying electrical power, (c) an electromechanical circuit 204 operatively connected to the heating element 12 and to the power supply 202, for transmitting the electrical power from the power supply 202 to the heating element 12 for lighting the cigarette 14, and (d) a portable hand holdable housing 206 for housing the heating element 12, the power supply 202, and the electromechanical circuit 204 in a fully operable configuration.

Portable hand holdable electric cigarette lighter 200, as illustrated in FIG. 3, features a specific physical and spatial layout or configuration, and geometrical dimensions, particularly ready for use when being carried and moved around, for example, in a clothes pocket, purse, or small bag, but is also ready for use when located on top of an article of furniture or a shelf.

In portable hand holdable electric cigarette lighter 200, electrical resistance heating element 12, hereinafter, equivalently referred to as heating element 12, is firmly supported and held by non-conductive support elements 24 and 26 which are either part of, or attached to, portable hand holdable housing 206. Conductive ends 28 and 30 of heating element 12 are connected to conductive contact points 32 and 34, respectively, located along the sides or inside of support elements 24 and 26, respectively.

Built-in internally located direct current (dc) power supply 202, hereinafter, equivalently referred to as internal (dc) power supply 202, is operatively connected, and supplies electrical power, to electromechanical circuit 204. Internal (dc) power supply 202 is, for example, one or more disposable or rechargeable batteries, or an electromagnetic direct current (dc) generator, which supplies the necessary electrical power, for example, having voltage in a range of between about 0.5 volts and about 25 volts, for enabling heating of heating element 12 to a desired cigarette or cigar lighting temperature, preferably, at least about 500° C.

As stated immediately above, electromechanical circuit 204 is operatively connected to heating element 12 and to (dc) power supply 202, for transmitting the electrical power from power supply 202 to heating element 12 for lighting cigarette 14.

Electromechanical circuit 204, hereinafter, generally referred to as electromechanical circuit 204, is an electromechanical circuit as generally defined hereinabove, that includes electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 206, which are applicable for transmitting the electrical power from internal (dc) power supply 202 to heating element 12 for lighting cigarette 14.

Electromechanical circuit 204 includes an actuating mechanism 36 (indicated in FIG. 3 by the dashed line rectangle) which actuates heating of heating element 12 for lighting cigarette 14. Actuating mechanism 36 is a finger activatable/thermally responsive finger deactivatable electromechanical mechanism, which is activated by the press or push (indicated in FIG. 3 by arrow 38) of a finger 40 and deactivated by release of the pressed or pushed finger 40 in response to visual detection of an increase in temperature of heating element 12 to a desired cigarette lighting temperature, preferably, at least about 500° C. Actuating mechanism 36 includes (1) a double-pole contactor switch assembly 42, hereinafter, equivalently referred to as switch assembly 42, and (2) a finger pressible/releasable rod or bar assembly 44, hereinafter, equivalently referred to as rod assembly 44.

Components, functions, and operation, of actuating mechanism 36 of electromechanical circuit 204 in the first exemplary specific configuration of the second preferred embodiment of the portable hand holdable electric cigarette lighter of the present invention, that is, in portable hand holdable electric cigarette lighter 200, as illustrated in FIG. 3, are the same as the components, functions, and operation, of actuating mechanism 36 of electromechanical circuit 16 in the first exemplary specific configuration of the first preferred embodiment of the portable hand holdable electric cigarette lighter of the present invention, that is, in portable hand holdable electric cigarette lighter 10, as previously described hereinabove and illustrated in FIG. 1. The only difference between the first exemplary specific configuration of the second preferred embodiment of the portable hand holdable electric cigarette lighter, that is, portable hand holdable electric cigarette lighter 200, as illustrated in FIG. 3, and the previously described first exemplary specific configuration of the first preferred embodiment of the portable hand holdable electric cigarette lighter, that is, portable hand holdable electric cigarette lighter 10, as illustrated in FIG. 1, with respect to actuating mechanism 36 of electromechanical circuit 204 (FIG. 3) and electromechanical circuit 16 (FIG. 1), respectively, has to do with the location and type of electrical power being supplied to electromechanical circuit 204 and electromechanical circuit 16, respectively, for activating actuating mechanism 36, for enabling heating of heating element 12 to an appropriate cigarette or cigar lighting temperature. More specifically, either a built-in internally located direct current (dc) power supply, that is, internal (dc) power supply 202 operatively connected to electromechanical circuit 204 (FIG. 3), or an externally located alternating current (ac) power supply, that is, external (ac) power supply 18 (FIG. 1) operatively connectable to electromechanical circuit 204.

Thus, for the first exemplary specific configuration of the second preferred embodiment of the portable hand holdable electric cigarette lighter, that is, portable hand holdable electric cigarette lighter 200, as illustrated in FIG. 3, in actuating mechanism 36 of electromechanical circuit 204, wires or leads 46 and 48 leading from conductive contact points 32 and 34, respectively, of heating element 12, are connected to a first pair of conductive contact points 50 and 52, respectively, of switch assembly 42. The two poles 54 and 56 of switch assembly 42 are movably connected to first pair of conductive contact points 50 and 52, respectively, of switch assembly 42, and are movably connectable to a second pair of conductive contact points 58 and 60, respectively, of switch assembly 42. Wires or leads 62 and 64 leading from second pair of conductive contact points 58 and 60, respectively, of switch assembly 42, are connected to a pair of output conductive contact points 208 and 210, respectively, of internal (dc) power supply 202.

For this first exemplary specific configuration of the second preferred embodiment of the portable hand holdable electric cigarette lighter, that is, portable hand holdable electric cigarette lighter 200, as illustrated in FIG. 3, as for the first exemplary specific configuration of the first preferred embodiment of the portable hand holdable electric cigarette lighter of the present invention, that is, in portable hand holdable electric cigarette lighter 10, previously described hereinabove and illustrated in FIG. 1, in actuating mechanism 36, the first end 44a, that is, the finger pressible/releasable end, of rod assembly 44, either includes or is connected to, a finger pressible/releasable element 86, in particular, a button or knob, and the second end 44b of rod assembly 44 is connected to the first end 88a of an elastic (compressible/decompressible) element 88, in particular, a spring, whose second end 88b is fixed, in particular, to an inside wall 90 of portable hand holdable housing 22. The two poles 54 and 56 of switch assembly 42 are movably connected, via connecting elements 92 and 94, respectively, to rod assembly 44.

For portable hand holdable electric cigarette lighter 200, as illustrated in FIG. 3, wherein internal (dc) power supply 202 is one or more disposable or rechargeable batteries, electromechanical circuit 204 is completely self-powerable, whereby electromechanical circuit 204 requires no externally located power supply for fully enabling heating of heating element 12 to a desired cigarette or cigar lighting temperature, preferably, at least about 500° C., for as long as the one or more disposable or rechargeable batteries are of sufficient charge. Following usage of portable hand holdable electric cigarette lighter 200, for a number, for example, on the order of at least several thousand, of cigarette or cigar lightings, the consumed internal (dc) power supply 202 is replaced with a new one, whereby the one or more disposable or rechargeable batteries are replaced with a corresponding number of new disposable or rechargeable batteries, or alternatively, the one or more rechargeable batteries are recharged by using, for example, an externally or internally located and operable battery recharging device, as illustratively described in more detail immediately following.

As just stated, alternatively, for portable hand holdable electric cigarette lighter 200, as illustrated in FIG. 3, wherein internal (dc) power supply 202 is one or more rechargeable batteries, electromechanical circuit 204 optionally, additionally includes a battery recharging control unit 212 which is operatively connected to the one or more rechargeable batteries of internal (dc) power supply 202, and operatively connectable to an externally located battery recharging device 214, hereinafter, equivalently referred to as external battery recharging device 214, which in turn, is operatively connectable to an externally located alternating current (ac) power supply, in particular, external (ac) power supply 18.

In such an alternative configuration, battery recharging control unit 212 is operatively connected to internal (dc) power supply 202 via a pair of output conductive contact points 216 and 218 of battery recharging control unit 212, connected to wires or leads 220 and 222 leading from a pair of conductive contact points 224 and 226, respectively, which are electrically in-line with internal (dc) power supply 202. Additionally, battery recharging control unit 212 is operatively connectable to external battery recharging device 214 via wires or leads 228 and 230 leading from a pair of input conductive contact points 232 and 234, respectively, of battery recharging control unit 212, and passing through ports or openings 236 and 238, respectively, of portable hand holdable housing 206, which are operatively connectable to electrical input ports 240 and 242, respectively, of external battery recharging device 214. External battery recharging device 214 is operatively connectable to external (ac) power supply 18 via wires or leads 244 and 246 leading from external battery recharging device 214 and operatively connectable to electrical sockets 82 and 84, respectively, of externally located alternating current (ac) power supply 18.

In a related alternative configuration of portable hand holdable electric cigarette lighter 200, as illustrated in FIG. 3, wherein internal (dc) power supply 202 is one or more rechargeable batteries, electromechanical circuit 204 optionally, additionally includes a combination of a battery recharging control unit and a battery recharging device, hereinafter, equivalently referred to as battery recharging control unit/battery recharging device 212, which is operatively connected to the one or more rechargeable batteries of internal (dc) power supply 202, and which is directly operatively connectable to an externally located alternating current (ac) power supply, in particular, external (ac) power supply 18.

In such an alternative configuration, battery recharging control unit/battery recharging device 212 is operatively connected to internal (dc) power supply 202 via a pair of output conductive contact points 216 and 218 of battery recharging control unit/battery recharging device 212, connected to wires or leads 220 and 222 leading from the pair of conductive contact points 224 and 226, respectively, which are electrically in-line with internal (dc) power supply 202. Additionally, battery recharging control unit/battery recharging device 212 is operatively connectable to external (ac) power supply 18 via wires or leads 228 and 230 leading from a pair of input conductive contact points 232 and 234, respectively, of battery recharging control unit/battery recharging device 212, and passing through ports or openings 236 and 238, respectively, of portable hand holdable housing 206, and which are directly operatively connectable to electrical sockets 84 and 82, respectively, of externally located alternating current (ac) power supply 18.

Alternatively, for portable hand holdable electric cigarette lighter 200, as illustrated in FIG. 3, wherein internal (dc) power supply 202 is an electromagnetic direct current (dc) generator, electromechanical circuit 204 additionally includes an electromagnetic direct current (dc) generator control unit 212, which is operatively connected to the electromagnetic direct current (dc) generator of internal (dc) power supply 202, and which is directly operatively connectable to an externally located alternating current (ac) power supply, in particular, external (ac) power supply 18.

In such an alternative configuration, electromagnetic direct current (dc) generator control unit 212 is operatively connected to internal (dc) power supply 202 via a pair of output conductive contact points 216 and 218 of electromagnetic direct current (dc) generator control unit 212, connected to wires or leads 220 and 222 leading from the pair of conductive contact points 224 and 226, respectively, which are electrically in-line with internal (dc) power supply 202. Additionally, electromagnetic direct current (dc) generator control unit 212 is operatively connectable to external (ac) power supply 18 via wires or leads 228 and 230 leading from a pair of input conductive contact points 232 and 234, respectively, of electromagnetic direct current (dc) generator control unit 212, and passing through ports or openings 236 and 238, respectively, of portable hand holdable housing 206, and which are directly operatively connectable to electrical sockets 84 and 82, respectively, of externally located alternating current (ac) power supply 18.

As illustrated in FIG. 3, in portable hand holdable electric cigarette lighter 200, finger pressible/releasable element (button or knob) 86 of rod assembly 44 and heating element 12 are each located along the top side of portable hand holdable housing 22, facing the upward direction, providing for convenient activation of actuating mechanism 36 and lighting of cigarette 14. Moreover, configured as shown in FIG. 3, actuating mechanism 36 of electromechanical circuit 204 is mostly located in the middle and upper portions, internal (dc) power supply 202 is mostly located in the middle and upper left side portions, and ports or openings 236 and 238 are located along the bottom side, of portable hand holdable housing 206.

As previously stated, portable hand holdable electric cigarette lighter 200, as illustrated in FIG. 3, features a specific physical and spatial layout or configuration, and geometrical dimensions, ready for use when being carried and moved around, for example, in a clothes pocket, purse, or small bag, but is also ready for use when located on top of an article of furniture or a shelf. With reference to reference xyz-coordinate system 99 shown in FIG. 3, whereby the xz-plane corresponds to the plane of the paper, and the y-axis is perpendicular thereof, preferred ranges of values and preferred values of geometrical dimensions (length, height, and width or depth) of portable hand holdable housing 206 are as follows. Value of length, along the x-axis, is preferably in a range of between about 1 cm and about 6 cm, and is preferably about 3 cm. Value of height, along the z-axis, is preferably in a range of between about 5 cm and about 12 cm, and is preferably about 8 cm. Value of width or depth, along the y-axis, is preferably in a range of between about 0.5 cm and about 5 cm, and is preferably about 1.5 cm.

In general, function and operation of portable hand holdable electric cigarette lighter 200, and devices, mechanisms, assemblies, components, and/or elements, therein, are not limited to the exemplary specific physical and spatial layout or configuration, and relative geometrical dimensions, illustrated in FIG. 3, or to the just stated exemplary preferred ranges of values and values of geometrical dimensions (length, height, and width or depth). Accordingly, the specific physical and spatial layout or configuration, and geometrical dimensions, of the devices, mechanisms, assemblies, components, and/or elements, such as finger pressible/releasable element (button or knob) 86 of rod assembly 44, heating element 12, actuating mechanism 36, internal (dc) power supply 202, and ports or openings 236 and 238, of portable hand holdable housing 206, of portable hand holdable electric cigarette lighter 200, inside and along the sides of portable hand holdable housing 206, is clearly variable.

For operating portable hand holdable electric cigarette lighter 200, a user activates actuating mechanism 36 of electromechanical circuit 204 by pressing or pushing (arrow 38) finger 40 against finger pressible/releasable element (button or knob) 86 of finger pressible/releasable rod assembly 44, and continues to hold finger pressible/releasable element 86 in the pressed or pushed condition, whereupon rod assembly 44 longitudinally moves and elastic (compressible/decompressible) element (spring) 88 compresses, towards inside wall 90 of portable hand holdable housing 206 (indicated in FIG. 3 by the filled-in head arrows parallel to rod assembly 44).

This action causes the initially unconnected ends of poles 54 and 56 of switch assembly 42 to longitudinally move towards, and become connected to, contact points 58 and 60, thereby putting switch assembly 42 and electromechanical circuit 204 in a closed and actuated state. Internal (dc) power supply 202, for example, one or more disposable or rechargeable batteries, or an electromagnetic direct current (dc) generator, as illustratively described hereinabove, supplies the necessary electrical power, for example, having voltage in a range of between about 0.5 volts and about 25 volts, to electromechanical circuit 204. The user continues to hold finger pressible/releasable element 86 in the pressed or pushed condition, while electromechanical circuit 204 transmits, via above illustratively described electrically conductive paths and contact points, the electrical power to heating element 12, until heating element 12 becoming heated to a sufficiently high temperature, preferably, at least about 500° C., for lighting cigarette 14.

Immediately upon visually detecting that heating element 12 reaches a sufficiently high temperature for lighting cigarette 14, for example, wherein heating element 12 emits a red hot glow, the user continues to hold finger pressible/releasable element 86 in the pressed or pushed condition, while lighting cigarette 14. Immediately after lighting cigarette 14, the user discontinues to hold and releases finger pressible/releasable element 86, whereupon rod assembly 44 longitudinally moves back to its initial position and elastic (compressible/decompressible) element (spring) 88 decompresses away from inside wall 90 of portable hand holdable housing 206. This action causes the connected ends of poles 54 and 56 of switch assembly 42 to become disconnected and longitudinally move away from contact points 58 and 60, thereby returning switch assembly 42 and electromechanical circuit 204 to an open and non-actuated state.

Alternatively, immediately upon visually detecting that heating element 12 reaches a sufficiently high temperature for lighting cigarette 14, just prior to lighting cigarette 14, the user discontinues to hold and releases finger pressible/releasable element 86, and then immediately lights cigarette 14. In this case, by the time the user has completed lighting cigarette 14, rod assembly 44 has already longitudinally moved back to its initial position and elastic (compressible/decompressible) element (spring) 88 has already decompressed away from inside wall 90 of portable hand holdable housing 206, whereupon the connected ends of poles 54 and 56 of switch assembly 42 have already become disconnected and longitudinally moved away from contact points 58 and 60, thereby having returned switch assembly 42 and electromechanical circuit 204 to an open and non-actuated state.

Following operation of portable hand holdable electric cigarette lighter 200 for lighting cigarette 14, portable hand holdable electric cigarette lighter 200 can be conveniently carried around in a clothes pocket, purse, or small bag, of the user, located on top of an article of furniture (for example, a desk or drawer unit) or a shelf, plugged into a wall electrical outlet or other suitable electrical outlet for either recharging the one or more rechargeable batteries of internal (dc) power supply 202 or for use wherein internal (dc) power supply 202 is an electromagnetic direct current (dc) generator, stored in a storage area, and/or moved between such locations, again ready for immediate and routine use for lighting cigarette 14.

FIG. 4 is a schematic diagram illustrating an open (front, back, or in between) side view of the second exemplary specific configuration, and alternative configurations thereof, of the second preferred embodiment of the portable hand holdable electric cigarette lighter, wherein the electromechanical circuit for heating of the heating element is supplied electrical power from a built-in internally located power supply, and the actuating mechanism is a finger activatable/thermally responsive automatically deactivatable electromechanical mechanism, for lighting a cigarette or cigar.

As shown in FIG. 4, the second exemplary specific configuration, and alternative configurations thereof, of the second preferred embodiment of the portable hand holdable electric cigarette lighter, hereinafter, referred to as portable hand holdable electric cigarette lighter 300, of the present invention, each includes the following main components and functions thereof: (a) an electrical resistance heating element 12 contactable by a cigarette or cigar 14, hereinafter, equivalently referred to as cigarette 14, for lighting the cigarette 14, (b) a built-in internally located direct current (dc) power supply 202 for supplying electrical power, (c) an electromechanical circuit 302 operatively connected to the heating element 12 and to the power supply 202, for transmitting the electrical power from the power supply 202 to the heating element 12 for lighting the cigarette 14, and (d) a portable hand holdable housing 304 for housing the heating element 12, the power supply 202, and the electromechanical circuit 302 in a fully operable configuration.

Portable hand holdable electric cigarette lighter 300, as illustrated in FIG. 4, features a specific physical and spatial layout or configuration, and geometrical dimensions, particularly ready for use when being carried and moved around, for example, in a clothes pocket, purse, or small bag, but is also ready for use when located on top of an article of furniture or a shelf.

In portable hand holdable electric cigarette lighter 300, electrical resistance heating element 12, hereinafter, equivalently referred to as heating element 12, is firmly supported and held by non-conductive support elements 116 and 118 which are either part of, or attached to, end elements 120 and 122, respectively, of a longitudinally extendable inner assembly 112 of actuating mechanism 306 of electromechanical circuit 302. Conductive ends 28 and 30 of heating element 12 are connected to thermally conductive contact points 124 and 126, respectively, located along the sides or inside of support elements 116 and 118, respectively.

Built-in internally located direct current (dc) power supply 202, hereinafter, equivalently referred to as internal (dc) power supply 202, is operatively connected, and supplies electrical power, to electromechanical circuit 302. Internal (dc) power supply 202 is, for example, one or more disposable or rechargeable batteries, or an electromagnetic direct current (dc) generator, which supplies the necessary electrical power, for example, having voltage in a range of between about 0.5 volts and about 25 volts, for enabling heating of heating element 12 to a desired cigarette or cigar lighting temperature, preferably, at least about 500° C.

As stated immediately above, electromechanical circuit 302 is operatively connected to heating element 12 and to (dc) power supply 202, for transmitting the electrical power from power supply 202 to heating element 12 for lighting cigarette 14.

Electromechanical circuit 302, hereinafter, generally referred to as electromechanical circuit 302, is an electromechanical circuit as generally defined hereinabove, that includes electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 304, which are applicable for transmitting the electrical power from internal (dc) power supply 202 to heating element 12 for lighting cigarette 14.

Electromechanical circuit 302 includes an actuating mechanism 106 (indicated in FIG. 4 by the dashed line rectangle) which actuates heating of heating element 12 for lighting cigarette 14. Actuating mechanism 106 is a finger activatable/thermally responsive automatically deactivatable electromechanical mechanism, which is activated by the press or push (indicated in FIG. 4 by arrow 38) of a finger 40 and automatically deactivated in response to an increase in temperature of heating element 12 to a pre-determined threshold temperature, preferably, at least about 500° C., sufficient for lighting cigarette 14. This type of electromechanical mechanism includes (1) a finger pressible and removable contacting assembly 108, hereinafter, equivalently referred to as removable contacting assembly 108, contactable with (2) an automatic thermally expandable and releasable contacting assembly 110, hereinafter, equivalently referred to as releasable contacting assembly 110.

Components, functions, and operation, of actuating mechanism 106 of electromechanical circuit 302 in the second exemplary specific configuration of the second preferred embodiment of the portable hand holdable electric cigarette lighter of the present invention, that is, in portable hand holdable electric cigarette lighter 300, as illustrated in FIG. 4, are the same as the components, functions, and operation, of actuating mechanism 106 of electromechanical circuit 102 in the second exemplary specific configuration of the first preferred embodiment of the portable hand holdable electric cigarette lighter of the present invention, that is, in portable hand holdable electric cigarette lighter 100, as previously described hereinabove and illustrated in FIG. 2. The only difference between the second exemplary specific configuration of the second preferred embodiment of the portable hand holdable electric cigarette lighter, that is, portable hand holdable electric cigarette lighter 300, as illustrated in FIG. 4, and the previously described second exemplary specific configuration of the first preferred embodiment of the portable hand holdable electric cigarette lighter, that is, portable hand holdable electric cigarette lighter 100, as illustrated in FIG. 2, with respect to actuating mechanism 106 of electromechanical circuit 302 (FIG. 4) and electromechanical circuit 102 (FIG. 2), respectively, has to do with the location and type of electrical power being supplied to electromechanical circuit 302 and electromechanical circuit 102, respectively, for activating actuating mechanism 106, for enabling heating of heating element 12 to an appropriate cigarette or cigar lighting temperature. More specifically, either a built-in internally located direct current (dc) power supply, that is, internal (dc) power supply 202 operatively connected to electromechanical circuit 302 (FIG. 4), or an externally located alternating current (ac) power supply, that is, external (ac) power supply 18 (FIG. 2) operatively connectable to electromechanical circuit 102.

Thus, for the second exemplary specific configuration of the second preferred embodiment of the portable hand holdable electric cigarette lighter, that is, portable hand holdable electric cigarette lighter 300, as illustrated in FIG. 4, in actuating mechanism 106 of electromechanical circuit 302, finger pressible removable contacting assembly 108 includes a longitudinally movable inner assembly 112, hereinafter, equivalently referred to as inner assembly 112, having a first end portion 112a positioned inside of a longitudinally movable outer assembly 114, hereinafter, equivalently referred to as outer assembly 114. Non-conductive support elements 116 and 118 which are either part of, or attached to, end elements 120 and 122, respectively, of the second end portion 112b of inner assembly 112, firmly support and hold heating element 12. Conductive ends 28 and 30 of heating element 12 are connected to conductive contact points 124 and 126, respectively, located along the sides or inside of support elements 116 and 118, respectively. Thermally conductive wires 128 and 130 leading from thermally conductive contact points 124 and 126, respectively, of heating element 12, are connected to thermally conductive contact elements 132 and 134, respectively, of end elements 120 and 122, respectively, of second end portion 112b of inner assembly 112.

Outer assembly 114 of removable contacting assembly 108 includes a finger pressible element 136, in particular, a button or knob, which is connected to the first end 138a of a longitudinally movable rod or bar 138. The second end 138b of rod or bar 138 is connected to the first end 140a of an elastic (compressible/decompressible) element 140, in particular, a spring. The second end 140b of elastic element 140 is connected to the first end 142a of a longitudinally movable connecting element 142 which is fixed to a support element 144 of inner assembly 112 extending across approximately the middle portion of inner assembly 112. The outer sides 146 and 148 of outer assembly 114 are movably supported or held by non-conductive elements 150 and 152, respectively, which are either included as part of, or connected to, the inside of the top portion of portable hand holdable housing 304.

In actuating mechanism 106, automatic thermally expandable and releasable contacting assembly 110 includes thermally expandable conductive elements 154 and 156. More specifically, following a relatively short period of time, for example, on the order of less than about one minute, preferably, less than about 30 seconds, and more preferably, less than about 5 seconds, of being in physical and thermal contact with thermally conductive contact elements 132 and 134 of end elements 120 and 122, respectively, of second end portion 112b of inner assembly 112, (indicated in FIG. 4 by the dashed lined ‘shadow’ of heating element 12 and selected components of second end portion 112b of inner assembly 112), for receiving heat generated by heating element 12 and transmitted along thermally conductive wires 128 and 130 and along thermally conductive contact elements 132 and 134, respectively, the first end and middle portions 154′ of thermally expandable conductive element 154, and, the first end and middle portions 156′ of thermally expandable conductive element 156, thermally outwardly expand in the direction toward the inside walls of the middle portion of portable hand holdable housing 304.

Second end portion 154″ of thermally expandable conductive element 154, and, second end portion 156″ of thermally expandable conductive element 156, are electrically separated or insulated from each other by a non-conductive electrical insulating element 158. Non-conductive electrical insulating element 158 and, the end portions 154″ and 156″ of thermally expandable conductive elements 154 and 156, respectively, are rigidly fixed to a non-conductive support element 160 extending across the inside walls of portable hand holdable housing 304.

Conductive elements 154 and 156 are connected to and supported by either conductive or non-conductive support elements 162 and 164, respectively. Located along the sides, or inside, of support elements 162 and 164 are conductive contact points 166 and 168, respectively Wires or leads 170 and 172 leading from conductive contact points 166 and 168, respectively, of releasable contacting assembly 110, are connected to a pair of output conductive contact points 208 and 210, respectively, of internal (dc) power supply 202.

For portable hand holdable electric cigarette lighter 300, as illustrated in FIG. 4, wherein internal (dc) power supply 202 is one or more disposable or rechargeable batteries, electromechanical circuit 204 is completely self-powerable, whereby electromechanical circuit 302 requires no externally located power supply for fully enabling heating of heating element 12 to a desired cigarette or cigar lighting temperature, preferably, at least about 500° C., for as long as the one or more disposable or rechargeable batteries are of sufficient charge. Following usage of portable hand holdable electric cigarette lighter 300, for a number, for example, on the order of at least several thousand, of cigarette or cigar lightings, the consumed internal (dc) power supply 202 is replaced with a new one, whereby the one or more disposable or rechargeable batteries are replaced with a corresponding number of new disposable or rechargeable batteries, or alternatively, the one or more rechargeable batteries are recharged by using, for example, an externally or internally located and operable battery recharging device, as illustratively described in more detail immediately following.

As just stated, alternatively, for portable hand holdable electric cigarette lighter 300, as illustrated in FIG. 4, wherein internal (dc) power supply 202 is one or more rechargeable batteries, electromechanical circuit 302 optionally, additionally includes a battery recharging control unit 212 which is operatively connected to the one or more rechargeable batteries of internal (dc) power supply 202, and operatively connectable to an externally located battery recharging device 214, which in turn, is operatively connectable to an externally located alternating current (ac) power supply, in particular, external (ac) power supply 18.

In such an alternative configuration, battery recharging control unit 212 is operatively connected to internal (dc) power supply 202 via a pair of output conductive contact points 216 and 218 of battery recharging control unit 212, connected to wires or leads 220 and 222 leading from a pair of conductive contact points 224 and 226, respectively, which are electrically in-line with internal (dc) power supply 202. Additionally, battery recharging control unit 212 is operatively connectable to external battery recharging device 214 via wires or leads 228 and 230 leading from a pair of input conductive contact points 232 and 234, respectively, of battery recharging control unit 212, and passing through ports or openings 236 and 238, respectively, of portable hand holdable housing 304, which are operatively connectable to electrical input ports 240 and 242, respectively, of external battery recharging device 214. External battery recharging device 214 is operatively connectable to external (ac) power supply 18 via wires or leads 244 and 246 leading from external battery recharging device 214 and operatively connectable to electrical sockets 82 and 84, respectively, of externally located alternating current (ac) power supply 18.

In a related alternative configuration of portable hand holdable electric cigarette lighter 300, as illustrated in FIG. 4, wherein internal (dc) power supply 202 is one or more rechargeable batteries, electromechanical circuit 204 optionally, additionally includes a combination of a battery recharging control unit and a battery recharging device, hereinafter, equivalently referred to as battery recharging control unit/battery recharging device 212, which is operatively connected to the one or more rechargeable batteries of internal (dc) power supply 202, and which is directly operatively connectable to an externally located alternating current (ac) power supply, in particular, external (ac) power supply 18.

In such an alternative configuration, battery recharging control unit/battery recharging device 212 is operatively connected to internal (dc) power supply 202 via a pair of output conductive contact points 216 and 218 of battery recharging control unit/battery recharging device 212, connected to wires or leads 220 and 222 leading from the pair of conductive contact points 224 and 226, respectively, which are electrically in-line with internal (dc) power supply 202. Additionally, battery recharging control unit/battery recharging device 212 is operatively connectable to external (ac) power supply 18 via wires or leads 228 and 230 leading from a pair of input conductive contact points 232 and 234, respectively, of battery recharging control unit/battery recharging device 212, and passing through ports or openings 236 and 238, respectively, of portable hand holdable housing 304, and which are directly operatively connectable to electrical sockets 84 and 82, respectively, of externally located alternating current (ac) power supply 18.

Alternatively, for portable hand holdable electric cigarette lighter 300, as illustrated in FIG. 4, wherein internal (dc) power supply 202 is an electromagnetic direct current (dc) generator, electromechanical circuit 302 additionally includes an electromagnetic direct current (dc) generator control unit 212, which is operatively connected to the electromagnetic direct current (dc) generator of internal (dc) power supply 202, and which is directly operatively connectable to an externally located alternating current (ac) power supply, in particular, external (ac) power supply 18.

In such an alternative configuration, electromagnetic direct current (dc) generator control unit 212 is operatively connected to internal (dc) power supply 202 via a pair of output conductive contact points 216 and 218 of electromagnetic direct current (dc) generator control unit 212, connected to wires or leads 220 and 222 leading from the pair of conductive contact points 224 and 226, respectively, which are electrically in-line with internal (dc) power supply 202. Additionally, electromagnetic direct current (dc) generator control unit 212 is operatively connectable to external (ac) power supply 18 via wires or leads 228 and 230 leading from a pair of input conductive contact points 232 and 234, respectively, of electromagnetic direct current (dc) generator control unit 212, and passing through ports or openings 236 and 238, respectively, of portable hand holdable housing 304, and which are directly operatively connectable to electrical sockets 84 and 82, respectively, of externally located alternating current (ac) power supply 18.

As illustrated in FIG. 4, in portable hand holdable electric cigarette lighter 300, finger pressible element (button or knob) 136 of outer assembly 114 of removable contacting assembly 108, is located along the top side of portable hand holdable housing 104, facing the upward direction, providing for convenient activation of actuating mechanism 106 and lighting of cigarette 14. Moreover, configured as shown in FIG. 4, actuating mechanism 106 of electromechanical circuit 302 is located in the upper middle portion, internal (dc) power supply 202 is located in the lower portion, and ports or openings 236 and 238 are located along the bottom side, of portable hand holdable housing 304.

As previously stated, portable hand holdable electric cigarette lighter 300, as illustrated in FIG. 4, features a specific physical and spatial layout or configuration, and geometrical dimensions, ready for use when being carried and moved around, for example, in a clothes pocket, purse, or small bag, but is also ready for use when located on top of an article of furniture or a shelf. With reference to reference xyz-coordinate system 99 shown in FIG. 4, whereby the xz-plane corresponds to the plane of the paper, and the y-axis is perpendicular thereof, preferred ranges of values and preferred values of geometrical dimensions (length, height, and width or depth) of portable hand holdable housing 304 are as follows. Value of length, along the x-axis, is preferably in a range of between about 1 cm and about 6 cm, and is preferably about 3 cm. Value of height, along the z-axis, is preferably in a range of between about 5 cm and about 12 cm, and is preferably about 8 cm. Value of width or depth, along the y-axis, is preferably in a range of between about 0.5 cm and about 5 cm, and is preferably about 1.5 cm.

In general, function and operation of portable hand holdable electric cigarette lighter 300, and devices, mechanisms, assemblies, components, and/or elements, therein, are not limited to the exemplary specific physical and spatial layout or configuration, and relative geometrical dimensions, illustrated in FIG. 4, or to the just stated exemplary preferred ranges of values and values of geometrical dimensions (length, height, and width or depth). Accordingly, the specific physical and spatial layout or configuration, and geometrical dimensions, of the devices, mechanisms, assemblies, components, and/or elements, such as finger pressible element (button or knob) 136 of outer assembly 114 of removable contacting assembly 108, actuating mechanism 106 of electromechanical circuit 302, internal (dc) power supply 202, and ports or openings 236 and 238, of portable hand holdable housing 304, of portable hand holdable electric cigarette lighter 300, inside and along the sides of portable hand holdable housing 304, is clearly variable.

For operating portable hand holdable electric cigarette lighter 300, a user activates actuating mechanism 106 of electromechanical circuit 302, by a momentary press or push (arrow 38) of finger 40 against finger pressible element 136. Inner assembly 112 of removable contacting assembly 108 longitudinally moves (indicated in FIG. 4 by the filled-in head arrow on each outer side of second end portion 112b of inner assembly 112) towards and into the space between thermally expandable conductive elements 154 and 156 of automatic thermally expandable and releasable contacting assembly 110, until thermally conductive contact elements 132 and 134, of end elements 120 and 122, respectively, of second end portion 112b of inner assembly 112, become physically held by, and make thermal contact with, first end and middle portions 154′ of thermally expandable conductive element 154, and, first end and middle portions 156′ of thermally expandable conductive element 156, respectively (indicated in FIG. 4 by the dashed lined ‘shadow’ of heating element 12 and selected components of second end portion 112b of inner assembly 112). Following a relatively short period of time, for example, on the order of less than about one minute, preferably, less than about 30 seconds, and more preferably, less than about 5 seconds, of this physical and thermal contact, the heat generated by heating element 12 and transmitted along thermally conductive wires 128 and 130 and along thermally conductive contact elements 132 and 134, respectively, of end elements 120 and 122, respectively, of second end portion 112b of inner assembly 112, causes first end and middle portions 154′ of thermally expandable conductive element 154, and, first end and middle portions 156′ of thermally expandable conductive element 156, to thermally outwardly expand a relatively small distance, for example, on the order of about a few millimeters, in the direction toward the inner walls of the middle portion of portable hand holdable housing 304.

This thermally outward expansion of first end and middle portions 154′ of thermally expandable conductive element 154, and, first end and middle portions 156′ of thermally expandable conductive element 156, causes automatic thermally expandable and releasable contacting assembly 110 to automatically release thermally conductive contact elements 132 and 134 of end elements 120 and 122, respectively, of second end portion 112b of inner assembly 112, whereupon inner assembly 112 of finger pressible removable contacting assembly 108 automatically longitudinally springs and moves back to its original position relative to outer assembly 114, while heating element 12 remains heated at a sufficiently high temperature, preferably, at least about 500° C., for lighting cigarette 14.

Immediately upon seeing and/or hearing automatic release of finger pressible element (button or knob) 136 as a result of inner assembly 112 of finger pressible removable contacting assembly 108 having automatically longitudinally sprung and moved back to its original position relative to outer assembly 114, the user grasps finger pressible element 136, and for increased stability of removal and holding, may also grasp the outer sides 146 and 148 of outer assembly 114, and pulls removable contacting assembly 108 out from the top portion of portable hand holdable housing 304. The user then lights cigarette 14 by bringing heating element 12, while still at a sufficiently high temperature for lighting cigarette 14, into contact with cigarette 14 until lit. Following completion of lighting cigarette 14, the user returns removable contacting assembly 108 back to its initial position inside of front end portions 304a of portable hand holdable housing 304.

Following operation of portable hand holdable electric cigarette lighter 300 for lighting cigarette 14, portable hand holdable electric cigarette lighter 300 can be conveniently carried around in a clothes pocket, purse, or small bag, of the user, located on top of an article of furniture (for example, a desk or drawer unit) or a shelf, plugged into a wall electrical outlet or other suitable electrical outlet for either recharging the one or more rechargeable batteries of internal (dc) power supply 202 or for use wherein internal (dc) power supply 202 is an electromagnetic direct current (dc) generator, stored in a storage area, and/or moved between such locations, again ready for immediate and routine use for lighting cigarette 14.

With reference to FIGS. 1-4, immediately following are described additional aspects, characteristics, and features, which are generally applicable to the above illustrative description of the two exemplary specific configurations, and alternative configurations thereof, of the first preferred embodiment of the portable hand holdable electric cigarette lighter of the present invention, wherein the electromechanical circuit is supplied electrical power from an externally located alternating current (ac) power supply (FIGS. 1 and 2), and of the two exemplary specific configurations, and alternative configurations thereof, of the second preferred embodiment of the portable hand holdable electric cigarette lighter of the present invention, wherein the electromechanical circuit is supplied electrical power from a built-in internally located direct current (dc) power supply (FIGS. 3 and 4).

In general, electrical resistance heating element 12 or heating element 12, can have any of a wide variety of different electrical, mechanical, electromechanical, and physicochemical, properties, characteristics, and behavior, and, geometrical configuration, shape or form, and dimensions, and can be made of any of a wide variety of different materials and/or combinations of materials, which are appropriate for implementing the above illustratively described portable electric cigarette lighter of the present invention.

In particular, wherein heating element 12 is fully operable when connected to the electromechanical circuit which is configured and located inside of the portable hand holdable housing. In particular, wherein heating element 12 can receive and handle a voltage of between about 0.5 volts and about 25 volts, and a current of up to about 10 amps, transmitted by an electromechanical circuit which is supplied electrical power either from an externally located alternating current (ac) power supply, or from a built-in internally located direct current (dc) power supply. Preferably, heating element 12 is stable when quickly heated to a sufficiently high temperature, preferably, at least about 500° C., within a brief time span of less than about one minute, preferably, less than about 30 seconds, and more preferably, less than about 5 seconds, for lighting a cigarette or cigar, during routine usage of the portable hand holdable electric cigarette lighter, for a number, for example, on the order of at least several thousand, of cigarette or cigar lightings.

Heating element 12, can be made of a pure metal, a metal alloy of at least two pure metals, an electrically conductive graphite material, an electrically conductive ceramic material, an electrically conductive composite material, and/or a combination thereof. Preferably, heating element 12 is made of a metal alloy, such as an alloy of nickel, chromium, and iron. A specific example of such a metal alloy is commonly known as Nichrome®. Heating element 12 may be made of a metal alloy based on nickel and chromium, for example, a NiCrAlY metal alloy, or a metal alloy based on iron and chromium, for example, an FeCrAlY metal alloy, or a combination thereof. Heating element 12 may be made of an electrically conductive ceramic material based on, for example, SiC, Al₂O₃, or ZrO₂, or a combination thereof As previously illustratively described hereinabove, in an alternative configuration of each of the first and second exemplary specific configurations of the second preferred embodiment of the portable hand holdable electric cigarette lighter, in particular, portable hand holdable electric cigarette lighter 200 and 300, as illustrated in FIGS. 3 and 4, respectively, wherein internal (dc) power supply 202 is one or more rechargeable batteries, each electromechanical circuit 204 and 302, respectively, optionally, additionally includes battery recharging control unit 212 which is operatively connected to the one or more rechargeable batteries of internal (dc) power supply 202, and operatively connectable to external battery recharging device 214, which in turn, is operatively connectable to external (ac) power supply 18.

In such alternative configurations of the present invention, battery recharging control unit 212 includes electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 206 (FIG. 3) and 304 (FIG. 4), respectively, which are applicable for automatically controlling the recharging, via operation of external battery recharging device 214, of the one or more rechargeable batteries of internal (dc) power supply 202, to a level of electrical power, for example, having voltage in a range of between about 0.5 volts and about 25 volts, sufficient for enabling heating of heating element 12 to a desired cigarette or cigar lighting temperature, preferably, at least about 500° C.

As previously illustratively described hereinabove, in a related alternative configuration of each of the first and second exemplary specific configurations of the second preferred embodiment of the portable hand holdable electric cigarette lighter, in particular, portable hand holdable electric cigarette lighter 200 and 300, as illustrated in FIGS. 3 and 4, respectively, wherein internal (dc) power supply 202 is one or more rechargeable batteries, each electromechanical circuit 204 and 302, respectively, optionally, additionally includes a combination battery recharging control unit/battery recharging device 212, which is operatively connected to the one or more rechargeable batteries of internal (dc) power supply 202, and which is directly operatively connectable to external (ac) power supply 18.

In such alternative configurations of the present invention, battery recharging control unit/battery recharging device 212 includes electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 206 (FIG. 3) and 304 (FIG. 4), respectively, which are applicable for automatically recharging, and for automatically controlling the recharging, of the one or more rechargeable batteries of internal (dc) power supply 202, to a level of electrical power, for example, having voltage in a range of between about 0.5 volts and about 25 volts, sufficient for enabling heating of heating element 12 to a desired cigarette or cigar lighting temperature, preferably, at least about 500° C.

As previously illustratively described hereinabove, in another alternative configuration of each of the first and second exemplary specific configurations of the second preferred embodiment of the portable hand holdable electric cigarette lighter, in particular, portable hand holdable electric cigarette lighter 200 and 300, as illustrated in FIGS. 3 and 4, respectively, wherein internal (dc) power supply 202 is an electromagnetic direct current (dc) generator, each electromechanical circuit 204 and 302, respectively, additionally includes electromagnetic direct current (dc) generator control unit 212, which is operatively connected to the electromagnetic direct current (dc) generator of internal (dc) power supply 202, and which is directly operatively connectable to external (ac) power supply 18.

In such alternative configurations of the present invention, the electromagnetic direct current (dc) generator of internal (dc) power supply 202 and electromagnetic direct current (dc) generator control unit 212 include electrical, electronic, electromagnetic, mechanical, and/or electromechanical, connected and/or connectable, and, operable and/or potentially operable, devices, mechanisms, assemblies, components, and/or elements, configured and located inside of portable hand holdable housing 206 (FIG. 3) and 304 (FIG. 4), respectively, which are applicable for automatically generating and controlling a direct current electrical power, for example, having voltage in a range of between about 0.5 volts and about 25 volts, sufficient for enabling heating of heating element 12 to a desired cigarette or cigar lighting temperature, preferably, at least about 500° C.

The portable hand holdable housing for housing the heating element and the electromechanical circuit in each of the exemplary specific configurations, and alternative configurations thereof, of each of the first and second preferred embodiments of the portable hand holdable electric cigarette lighter of the present invention, as described hereinabove and illustrated in FIGS. 1-4, is made of any of a wide variety of different types of materials. The portable hand holdable housing is of a single material or a combination of materials preferably exhibiting a combination of varying degrees of hardness, heat resistance, and repetitive heat cycling durability, properties, characteristics, and behavior, which are suitable for appropriately housing and enabling cost effective long term highly repetitive use and handling of the portable hand holdable electric cigarette lighter. Exemplary materials suitable for constructing the portable hand holdable housing are selected from the group consisting of metals, heat resistant polymers, in general, and heat resistant plastics, in particular, composite materials, and combinations thereof.

Thus, as taught from the above illustrative description, it is clearly seen and understood that a commonly shared main aspect of novelty and inventiveness of the portable hand holdable electric cigarette lighter of the present invention is the combination of being (1) portable, (2) hand holdable, and (3) hand operable. By housing an appropriate combination of electromechanical components of the portable hand holdable electric cigarette lighter, as illustratively described hereinabove, which are needed for immediate use of lighting a cigarette or cigar, in a fully operable configuration within a portable hand holdable housing, the portable hand holdable electric cigarette lighter is conveniently hand held, operated, carried, and moved around (for example, in a clothes pocket, purse, or small bag), located on top of an article of furniture (for example, a desk or drawer unit) or a shelf, plugged into a wall electrical outlet or other suitable electrical outlet, stored in a storage area, and/or moved between such locations, by an individual, ready for immediate and routine use for lighting a cigarette or cigar.

It is appreciated that certain aspects, characteristics, or features, of the invention, which are, for clarity, described in the context of separate embodiments, may also be provided in combination in a single embodiment. Conversely, various aspects, characteristics, or features, of the invention, which are, for brevity, described in the context of a single embodiment, may also be provided separately or in any suitable subcombination.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

While the invention has been described in conjunction with specific embodiments and examples thereof, it is evident that many alternatives, modifications and variations will be apparent to those skilled in the art. Accordingly, it is intended to embrace all such alternatives, modifications and variations that fall within the spirit and broad scope of the appended claims.

1. A portable hand holdable electric cigarette lighter, comprising:
(a) an electrical resistance heating element contactable by a cigarette, for lighting said cigarette;
(b) an electromechanical circuit operatively connected to said heating element and connectable to an externally located alternating current power supply providing a primary voltage of about 110 volts or about 220 volts, said electromechanical circuit includes a step-down voltage transformer for transforming said primary voltage to a secondary voltage in a range of between about 0.5 volts and about 25 volts, such that said electromechanical circuit transmits electrical power having said secondary voltage to said heating element for said lighting; and
(c) a portable hand holdable housing for housing said heating element and said electromechanical circuit.

2. The portable hand holdable electric cigarette lighter of claim 1, wherein said heating element is supported by non-conductive support elements which are part of or attached to said portable hand holdable housing.

3. The portable hand holdable electric cigarette lighter of claim 1, wherein said electromechanical circuit includes an actuating mechanism which actuates heating of said heating element.

4. The portable hand holdable electric cigarette lighter of claim 3, wherein said actuating mechanism is a finger activatable/thermally responsive finger deactivatable electromechanical mechanism, activated by press of a finger and deactivated by release of said pressed finger in response to visual detection of an increase in temperature of said heating element to a cigarette lighting temperature of at least about 500° C.

5. The portable hand holdable electric cigarette lighter of claim 4, wherein said actuating mechanism includes (1) a double-pole contactor switch assembly, and (2) a finger pressible/releasable rod or bar assembly.

6. The portable hand holdable electric cigarette lighter of claim 3, wherein said actuating mechanism is a finger activatable/thermally responsive automatically deactivatable electromechanical mechanism, activated by press of a finger and automatically deactivated in response to an increase in temperature of said heating element to a pre-determined threshold cigarette lighting temperature of at least about 500° C.

7. The portable hand holdable electric cigarette lighter of claim 6, wherein said actuating mechanism includes (1) a finger pressible and removable contacting assembly, contactable with (2) an automatic thermally expandable and releasable contacting assembly.

8. The portable hand holdable electric cigarette lighter of claim 7, wherein said finger pressible removable contacting assembly includes a longitudinally movable inner assembly having a first end portion positioned inside of a longitudinally movable outer assembly.

9. The portable hand holdable electric cigarette lighter of claim 1, wherein wires lead from a pair of input conductive contact points of said step-down voltage transformer, pass through ports or openings of said portable hand holdable housing, and are operatively connectable to said externally located alternating current power supply.

10. The portable hand holdable electric cigarette lighter of claim 9, wherein said externally located alternating current power supply is a wall electrical outlet.

11. The portable hand holdable electric cigarette lighter of claim 9, wherein said wires passing through said ports or openings of said portable hand holdable housing, are plugged directly into a wall electrical outlet.

12. The portable hand holdable electric cigarette lighter of claim 1, wherein ranges of values of geometrical dimensions of length, height, and width or depth, of said portable hand holdable housing are between about 5 cm and about 20 cm, between about 4 cm and about 15 cm, and between about 5 cm and about 15 cm, respectively.

13. The portable hand holdable electric cigarette lighter of claim 1, wherein values of geometrical dimensions of length, height, and width or depth, of said portable hand holdable housing are about 14 cm, about 8 cm, and about 10 cm, respectively.

14. The portable hand holdable electric cigarette lighter of claim 1, wherein said heating element receives and handles a voltage of between about 0.5 volts and about 25 volts, and a current of up to about 10 amps.

15. The portable hand holdable electric cigarette lighter of claim 1, wherein said heating element is stable when heated to a temperature of at least about 500° C. within a time span of less than about one minute.

16. The portable hand holdable electric cigarette lighter of claim 1, wherein said heating element is made of a material selected from the group consisting of a pure metal, a metal alloy of at least two said pure metals, an electrically conductive graphite material, an electrically conductive ceramic material, an electrically conductive composite material, and a combination thereof.

17. A portable hand holdable electric cigarette lighter, comprising:
(a) an electrical resistance heating element contactable by a cigarette, for lighting said cigarette;
(b) a built-in internally located direct current power supply for supplying electrical power;
(c) an electromechanical circuit operatively connected to said heating element and said power supply, for transmitting said electrical power from said power supply to said heating element for said lighting; and
(d) a portable hand holdable housing for housing said heating element, said power supply, and said electromechanical circuit.

18. The portable hand holdable electric cigarette lighter of claim 17, wherein said heating element is supported by non-conductive support elements which are part of or attached to said portable hand holdable housing.

19. The portable hand holdable electric cigarette lighter of claim 17, wherein said electromechanical circuit includes an actuating mechanism which actuates heating of said heating element.

20. The portable hand holdable electric cigarette lighter of claim 19, wherein said actuating mechanism is a finger activatable/thermally responsive finger deactivatable electromechanical mechanism, activated by press of a finger and deactivated by release of said pressed finger in response to visual detection of an increase in temperature of said heating element to a cigarette lighting temperature of at least about 500° C.

21. The portable hand holdable electric cigarette lighter of claim 20, wherein said actuating mechanism includes (1) a double-pole contactor switch assembly, and (2) a finger pressible/releasable rod or bar assembly.

22. The portable hand holdable electric cigarette lighter of claim 19, wherein said actuating mechanism is a finger activatable/thermally responsive automatically deactivatable electromechanical mechanism, activated by press of a finger and automatically deactivated in response to an increase in temperature of said heating element to a pre-determined threshold cigarette lighting temperature of at least about 500° C.

23. The portable hand holdable electric cigarette lighter of claim 22, wherein said actuating mechanism includes (1) a finger pressible and removable contacting assembly, contactable with (2) an automatic thermally expandable and releasable contacting assembly.

24. The portable hand holdable electric cigarette lighter of claim 23, wherein said finger pressible removable contacting assembly includes a longitudinally movable inner assembly having a first end portion positioned inside of a longitudinally movable outer assembly.

25. The portable hand holdable electric cigarette lighter of claim 17, wherein said internal direct current power supplies said electrical power having a voltage in a range of between about 0.5 volts and about 25 volts, for heating said heating element to a cigarette lighting temperature at least about 500° C.

26. The portable hand holdable electric cigarette lighter of claim 17, wherein said internal direct current power supply is selected from the group consisting of one or more disposable batteries, one or more rechargeable batteries, and an electromagnetic direct current generator.

27. The portable hand holdable electric cigarette lighter of claim 17, wherein said internal direct current power supply is one or more disposable batteries.

28. The portable hand holdable electric cigarette lighter of claim 17, wherein said internal direct current power supply is one or more rechargeable batteries, and said electromechanical circuit additionally includes a battery recharging control unit operatively connected to said one or more rechargeable batteries.

29. The portable hand holdable electric cigarette lighter of claim 28, wherein said battery recharging control unit is operatively connectable to an externally located battery recharging device.

30. The portable hand holdable electric cigarette lighter of claim 17, wherein said internal direct current power supply is one or more rechargeable batteries, and said electromechanical circuit additionally includes a combination of a battery recharging control unit and a battery recharging device operatively connected to said one or more rechargeable batteries.

31. The portable hand holdable electric cigarette lighter of claim 30, wherein said combination of a battery recharging control unit and a battery recharging device is operatively connectable to an externally located alternating current power supply.

32. The portable hand holdable electric cigarette lighter of claim 17, wherein said internal direct current power supply is an electromagnetic direct current generator.

33. The portable hand holdable electric cigarette lighter of claim 17, wherein said internal direct current power supply is an electromagnetic direct current generator, and said electromechanical circuit additionally includes an electromagnetic direct current generator control unit operatively connected to said electromagnetic direct current generator.

34. The portable hand holdable electric cigarette lighter of claim 33, wherein said electromagnetic direct current generator control unit is operatively connectable to an externally located alternating current power supply.

35. The portable hand holdable electric cigarette lighter of claim 17, wherein ranges of values of geometrical dimensions of length, height, and width or depth, of said portable hand holdable housing are between about 1 cm and about 6 cm, between about 5 cm and about 12 cm, and between about 0.5 cm and about 5 cm, respectively.

36. The portable hand holdable electric cigarette lighter of claim 17, wherein values of geometrical dimensions of length, height, and width or depth, of said portable hand holdable housing are about 3 cm, about 8 cm, and about 1.5 cm, respectively.

37. The portable hand holdable electric cigarette lighter of claim 17, wherein said heating element receives and handles a voltage of between about 0.5 volts and about 25 volts, and a current of up to about 10 amps.

38. The portable hand holdable electric cigarette lighter of claim 17, wherein said heating element is stable when heated to a temperature of at least about 500° C. within a time span of less than about one minute.

39. The portable hand holdable electric cigarette lighter of claim 17, wherein said heating element is made of a material selected from the group consisting of a pure metal, a metal alloy of at least two said pure metals, an electrically conductive graphite material, an electrically conductive ceramic material, an electrically conductive composite material, and a combination thereof.
